(19) United States
(12) Patent Application Publication
(10) Pub. No.: US 2026/0260538 A1
(43) Pub. Date: Sep. 3, 2026

(54) OVERSIGHT SECURITY SYSTEM FOR WORK ENVIRONMENTS

(71) Applicants: Trevor Outman, San Diego, CA (US); Gagan Kapoor, Calgary, CA (US)

(72) Inventors: Trevor Outman, San Diego, CA (US); Gagan Kapoor, Calgary, CA (US)

(21) Appl. No.: 19/319,904

(22) Filed: Sep. 5, 2025

Related U.S. Application Data
(63) Continuation-in-part of application No. 19/067,927, filed on Mar. 2, 2025.

(51) Int. Cl. G07F 17/32; G06V 20/40; G06V 20/52; G06V 40/16; G10L 15/183; G10L 15/22; H04N 7/18

(52) U.S. Cl. CPC G07F 17/3241; G06V 20/44; G06V 20/52; G06V 40/172; G10L 15/183; G10L 15/22; H04N 7/181; G10L 2015/223

(57) ABSTRACT

A system for overseeing security at a gaming facility including: at least two live video streaming cameras having non-identical fields of view; a feed from the cameras to a central processor; at least two audio transmission-reception devices providing audio feed into the central processor; at least one audio transmission-reception device dedicated to a first pre-authorized casino personnel through at least one of the live video stream cameras; the at least one of the at least two audio-transmission-reception devices being fed into the processor is interpreted by the central processor through execution of Large Language Model software, which Large Language Model software converts words spoken by the authorized casino personnel into digital commands to be executed by the central processor, and the central processor is configured to respond to the digital commands by performing at least one action.

### REFERENCE TO RELATED APPLICATIONS

This application claims priority under 35 U.S.C. 120 as a Continuation-in-Part from U.S. Ser. No. 19/067,927, filed 2 Mar. 2025 and titled Oversight Security System for Work Environments (which is incorporated by reference herein in its entirety), which in turn claims priority from three U.S. Utility Provisional Applications Ser. Nos. 63/729,201, filed 6 Dec. 2024; 63/730,342, filed 10 Dec. 2024; and 64/730,400, filed 10 Dec. 2024. These applications are incorporated herein by reference in their entireties.

### BACKGROUND OF THE INVENTION

### Field of the Invention

The invention relates to the field of operation of activities within the environment of a casino, especially casino gaming tables, EGMs, interactive human activities. Automated and analytic steps are executed by a processor to evaluate quality and concerns about the activities.

### Background of the Art

The following published intellectual property identifies systems and processes that might be incorporated into the practices of the present invention. These public documents are incorporated by reference in their entireties herein.

U.S. Pat. No. 6,991,544, a method of automating a card game, comprising: wirelessly interrogating each of a plurality of playing cards using radio frequency transmissions; and for at least some of the playing cards, determining a rank of the playing card based on the wireless interrogation using a mapping stored on a computer-readable medium that uniquely identifies playing cards based on a random distribution of conductive material, comprising a plurality of conductive particles, carried by each of the playing cards.

U.S. Pat. No. 7,222,852, a device for identifying playing cards in a stack of playing cards, the device including: a first card support surface to supportingly engage at least a portion of a long edge of each of a number of playing cards in the stack of playing cards, a second card support surface extending at an angle to the first card supporting surface to supportingly engage at least a portion of a short edge of each of the number of playing cards in the stack of playing cards, and a third card support surface for engagingly supporting a surface of an outermost one of the playing cards in the stack of playing cards, the third card support surface forming a first obtuse angle with the first card support surface and a second obtuse angle with respect to the second card support surface, the first, the second and the third card support surfaces forming a receptacle sized and dimensioned for receiving at least a portion of the stack of playing cards; and a reading mechanism positioned to read a first indicia extending along a long edge of the playing cards and a second indicia extending along a short edge of the playing cards.

U.S. Pat. No. 7,950,661, a method of automating a card game including: wirelessly interrogating each of a plurality of playing cards using radio frequency transmissions; and for at least some of the playing cards, determining a rank of the playing card based on the wireless interrogation using a mapping stored on a computer-readable medium that uniquely identifies playing cards based on a random distribution of conductive material, comprising a plurality of conductive particles, carried by each of the playing cards.

U.S. Pat. No. 7,427,234, a method of facilitating gaming, the method comprising: determining an outcome of a primary wager by a primary player based at least in part on an outcome of a gaming event; and determining an outcome of a secondary wager by a secondary player based at least in part on the determined outcome of the primary wager and a set of odds associated with the primary player indicative of a success rate of the primary player's previous play.

U.S. Pat. No. 7,736,236, a method of operating a card game evaluation system for evaluating card games, the method including: for each round of a card game having a plurality of players: automatically determining a sequence of a set of playing cards in a deck of playing cards by a processor of the card game evaluation system, prior to dealing any of the playing cards from the deck; for each player, generating a plurality of working solutions representing possible valid and invalid outcomes of each of the player's hands by the processor of the card game evaluation system, based at least in part on the determined sequence of the set of playing cards; and for each player, reducing the plurality of working solutions to a final solution representing a valid outcome of each of the player's hands by the processor of the card game evaluation system, based at least in part on identities of playing cards that have been discarded during the card game, wherein validity of each respective working solution is determined by the processor of the card game evaluation system using a comparison between a number of hit cards dealt in each respective working solution and a subsequent player's next hit card.

U.S. Pat. No. 7,575,234, a method of wagering including: automatically gathering statistics about a primary player, the statistics based at least in part on a number of games previously won or lost by the primary player; processing the statistics on a host computing system to determine at least a win/loss percentage corresponding to the primary player; receiving a primary wager from the primary player regarding an outcome of a gaming event; transmitting primary wager information to the host computing system; transmitting the statistics about the at least one primary player to a secondary player; receiving a secondary wager placed by the secondary player, the secondary wager being placed after the secondary player reviewed the statistics; transmitting secondary wager information to the host computing system; determining the outcome of the gaming event; determining the outcome of the primary wager at the host computing system based on the determined outcome of the gaming event; and determining the outcome of the secondary wager at the host computing system based on the determined outcome of the primary wager.

U.S. Pat. No. 6,579,180, a method of tracking customer activity in a casino including; identifying a customer at a gaming table wherein identifying a customer includes: reading a unique serial number from a wagering piece each time the wagering piece is placed as a wager; tracing a path of the wagering piece between the casino and a plurality of customers including the customer; and matching the unique serial number to a customer identifier; automatically determining an amount won or lost by the customer at the gaming table; and determining a level of complimentary benefits to be provided to the customer based on the determined won or lost amount.

U.S. Pat. No. 6,530,837, a wager monitoring system including a computer programmed to monitor wagering on a gaming table by: determining a respective amount of each of a number of wagers on the gaming table; determining an outcome of the game play; automatically determining a respective amount of a number of payouts and takes based on the determined waters and the determined outcome of the game play; and a chip tray imager having a field-of-view encompassing at least a portion of a chip tray and coupled to provide chip tray information to the computer. Also disclosed is a wager monitoring system including a computer programmed to monitor wagering on a gaming table by: determining a respective amount of each of a number of wagers on the gaming table; determining an outcome of the game play; automatically determining a respective amount of a number of payouts and takes based on the determined waters and the determined outcome of the game play; and a card deck reader coupled to provide card deck sequence information to the computer.

U.S. Pat. No. 6,663,490, a method of detecting suspect player wagering patterns, including: monitoring a number of plays of a game; automatically determining a number of successful outcomes that is equal to the number of plays of the game having a successful outcome; comparing the number of successful outcomes to a statistically predictable number of successful outcomes for the game; and identifying a statistical aberration in the number of successful outcomes.

U.S. Pat. No. 6,527,271, a system to read card hands including: a card guide forming a card slot sized and dimensioned to receive an initial hand of playing cards including at least two playing cards; a reader positioned with respect to the card slot to simultaneously acquire a respective optically encoded identifier from each of at least two playing cards in the initial hand; and a decoder coupled to receive and decode signals from the reader corresponding to the acquired identifiers, wherein the reader comprises: a prism assembly including a first prism portion and a second prism portion, the second prism portion having a side parallel to a side of the first prism portion and spaced therefrom by a distance sufficient to receive the initial hand of playing cards therebetween; and an imager disposed along an optical path from the first and the second prism portions.

U.S. Pat. No. 6,579,181, a method of reading chips in a chip tray including: locating a plurality of chips in a first well of a chip tray, each of the chips having an information encoding pattern on a respective circumference of the chip; receiving light reflected from the circumference of the plurality of chips through a first window formed in the first well at a reading head; and producing a signal corresponding to a modulation pattern of the reflected light. A method of reading chips in a chip tray, the chip tray having a number of wells, each well sized to hold a plurality of stacked chips and having at least one window exposing a portion of a circumference of any chips stored in the well, the circumference of the chips bearing machine-readable identification information, the method including: moving a reading head with respect to a number of the windows in the chip tray; receiving light reflected from the circumference of any chips in the wells at the reading head; capturing the received light as electronic data at a number of successive positions of the reading head; and decoding the captured electronic data.

U.S. Pat. No. 6,652,379, a chip tray reader for storing chips for wagering including: a chip tray having a chip carrying surface including a top side and a bottom side, the top side forming a number of wells sized to receive chips therein, a window formed in each of the wells to expose a portion of a circumference of any chips when located in the wells; a reading head positioned beneath the bottom side of the chip carrying surface, the reading head having a field-of-view including at least a portion of at least one of the windows; a drive mechanism coupled to drive the reading head. An apparatus for temporarily holding wagering pieces including: a carrying surface having a number of receptacles formed therein, each of the number of receptacles sized to receive a number of stacked wagering pieces, and each of the number of receptacles having a window formed therein; and a reading head opposed across the carrying surface with respect to the wells, the reading head having a field-of-view including at least a portion of at least two of the windows.

U.S. Pat. No. 6,685,568, a discard card reader for reading information from an information bearing portion of one or more playing cards which has completed hands of playing cards, the discard card reader including: a housing having a base; a card cradle sized and dimensioned to receive one or more completed hands of playing cards, the card cradle including a card support surface sloped with respect to the base to simultaneously expose the information bearing portion of at least two of a number of playing cards supported by the card support surface; and a reading head positioned in the housing to read information from at least some of the playing cards when supported by the card support surface.

U.S. Pat. No. 6,964,612, an automated system to monitor cards including: a card deck reader capable of reading identifying information from a number of playing cards forming a deck of playing cards from which a card game is dealt; a dealer hand reader capable of reading identifying information from a number of the playing cards forming a dealer's initial hand after the playing cards forming the dealer's initial hand are dealt and before the playing cards forming the dealer's initial hand are collected; a discard card reader capable of reading identifying information from a number of the playing cards forming a dealer's complete hand and a player's complete hand after the playing cards forming the dealer's complete hand and the player's complete hand are collected; and at least one processor coupled to receive the read identifying information from the card deck reader, the dealer hand reader and the discard card reader, and programmed to process the read identifying information by: determining a sequence of the playing cards in the deck, prior to a dealer dealing any of the playing cards in a card game; determining an identity of each of a number of playing cards forming a dealer's initial hand; determining a sequence of a number of discarded playing cards including at least one player's complete hand and the dealer's complete hand; determining a position of the dealer's initial hand in the sequence of the discarded playing cards; determining a number of active hands played by players during the card game; for each of a number of players and for each hand played by the player, determining a value of each of a number of playing cards forming the player's completed hand; for each of the number of players and for each hand played by the player, determining a value of the player's completed hand from the determined value of each of the number of playing cards forming the player's completed hand; determining a value of each of a number of playing cards forming the dealer's completed hand; and determining a value of the dealer's completed hand from the determined value of each of the number of playing cards forming the dealer's completed hand.

U.S. Pat. No. 7,905,784, a system for analyzing a card game played on a playing surface of a gaming table, the system including: an optical reader operable to read an identifier from each of a number of playing cards collected after completion of at least one hand of at least one player of the card game to determine an ending sequence of playing cards; detecting means for detecting a dealing of at least one playing card to the at least one hand of the at least one player, before determining the ending sequence of playing cards; and means for automatically determining a value of the at least one hand based at least in part on the ending sequence and based at least in part on the detected dealing of at least one playing card to the at least one hand of the at least one player.

U.S. Pat. No. 7,770,893, an automated system to monitor card games played with playing cards, the automated system including: a card reader that reads identifying information from a first plurality of collected playing cards received by the card reader, the collected playing cards forming a first number (N), which is at least two, of hands of collected playing cards collected from at least two participants of a card game; and at least one processor coupled to the card reader to receive a sequence of identifying information read by the card reader, wherein the sequence of identifying information corresponds to an order of the collected playing cards are received by the card reader, and that determines a succession of collected playing card identities based at least in part on the sequence of identifying information, wherein the succession of collected playing card identities is comprised of respective playing card identities corresponding to the first plurality of collected playing cards, and that determines a second number (M) of sets of playing card identities from the succession of collected playing card identities, the first number (N) and the second number (M) being the same value, based at least in part on an order of the succession of collected playing card identities and a specified pick-up order of the first number (N) of collected hands of playing cards, wherein each respective set of playing card identities of the second number (M) of sets of playing card identities corresponds to a respective hand of collected playing cards of the first number (N) of collected hands of playing cards, and that further determines a respective value of a respective hand of collected playing cards based on the corresponding respective set of playing card identities for each one of the first number (N) of hands of collected playing cards.

U.S. Pat. No. 6,460,848, a card deck reader, including: a housing having a cradle sized to receive a plurality of playing cards; and a reading head positioned in the housing to read a respective symbol on each of the playing cards before a first one of the plurality of playing cards is manually removed from the housing.

U.S. Pat. No. 7,316,615, a method of tracking players in a casino gaming environment, the method including: from time-to-time, automatically associating a unique identifier of at least one of a number of wagering pieces presented by a non-identified patron at one or more locations in the casino gaming environment with the non-identified patron; from time-to-time in response to the automatically associating of the unique identifier of at least one of the number of wagering pieces presented by the non-identified patron, determining at least one aspect of the non-identified patron's behavior at the respective location in the casino gaming environment; from time-to-time, storing information regarding the determined at least one aspect of the non-identified patron's behavior in a database; and determining at least one value on which an award of a complimentary benefit is based.

U.S. Pat. No. 6,857,961, a method of analyzing a card game, the method including: manually collecting each of a number of playing cards dealt in a card game after a completion of at least one round, including at least one complete hand of playing cards of at least one player playing the card game; automatically reading an identifier from each of the number of collected playing cards, the order of identifiers read from the collected playing cards forming an ending sequence of the read identifiers; automatically detecting a dealing of each of the playing cards to the at least one hand of the at least one player; automatically determining a number of playing cards dealt to the at least one hand of the at least one player based at least in part on the detected dealings; and automatically determining a value of the at least one hand of the at least one player based at least in part on the ending sequence of the read identifiers and based at least in part on the determined number of playing cards dealt to the at least one hand of the at least one player.

U.S. Pat. No. 6,712,696, a gaming table monitoring system to monitor a game played at a gaming table, including: a bank on the gaming table for holding a number of chips associated with a house; a chip reader positioned to image the chips in the bank, the chip reader having an output to carry a bank image signal corresponding to the image of the chips in the bank; a table imager positioned to image at least a chip placement portion of a playing surface of the gaming table including a number of chips on the playing surface associated with at least one player, the table imager having an output to carry a table image signal corresponding to the image of the playing surface portion and the chips on the chip placement playing surface portion; and a computer coupled to the outputs of the bank reader and the table imager and programmed to track the chips in the bank and the chips on the playing surface portion of the gaming table.

U.S. Pat. No. 6,517,435, a method of monitoring employees at a gaming table, including: determining a value of a bank at the gaming table prior to game play; determining a respective amount of each of a number of wagers on the gaming table; determining an outcome of the game play; determining an amount of payouts and takes for each of the wagers based on the determined amounts of the wagers and the determined outcome of the game play; determining the value of the bank at the gaming table after the game play; reconciling the determined payouts and takes with the determined value of the bank prior to game play and the determined value of the bank after the game play; and identifying discrepancies from the reconciliation.

U.S. Pat. No. 7,011,309, a method of automatically reading playing cards, includes: positioning a plurality of playing cards in a housing to expose a symbol carrying portion of each of the cards; automatically reading a respective symbol from the symbol carrying portion of each of the playing cards in the plurality of playing cards before a first one of the playing cards is removed from the housing to establish a playing card order; and removing the plurality of playing cards from the housing such that each of the playing cards retains an order with respect to the other playing cards in the plurality of playing cards corresponding to an order in which the symbols were read; and for each of the playing cards, decoding a respective one of the read symbols only if the playing card is dealt.

U.S. Pat. No. 6,517,436, A gaming table monitor includes: a chip tray having a base including a front portion, and a chip carrying surface supported by the base, the chip carrying surface including a number of wells sized to receive chips therein; and a first table imaging camera mounted in the chip tray, the first table imaging camera having a first table imaging field-of-view extending outwardly from the front portion of the base.

### SUMMARY OF THE INVENTION

A system and method of using that system engaging Large Language Models to clarify directed activity at a gaming environment includes combinations of at least two cameras, at least two communication data entry systems for pre-authorized personnel and a central processor that executes commands from at least one of at least two data entry systems.

### BRIEF DESCRIPTION OF THE FIGURES

FIG. 1 shows a schematic of operation of the system of the present invention.

FIG. 2 illustrates a schematic diagram of a system for monitoring gaming activities according to one or more embodiments of the present disclosure.

FIG. 3 illustrates a schematic block diagram of a method for monitoring gaming activities according to one or more embodiments of the present disclosure.

FIG. 4 illustrates an alternative embodiment of the game table according to one or more embodiments of the present disclosure.

FIG. 5 illustrates an example of one or more masks corresponding to a plurality of gaming tokens according to one or more embodiments of the present disclosure.

FIG. 6 illustrates an example of a display incorporated into the game table according to one or more embodiments of the present disclosure.

FIG. 7 illustrates an example of a display incorporated into the game table 20 displaying a focused view according to one or more embodiments of the present disclosure.

### DETAILED DESCRIPTION OF THE INVENTION

A system for overseeing security at a gaming facility, such as a casino, card room, small facility game room and hall comprising:
A. At least two live video streaming cameras having non-identical fields of view;

The fields may overlap to some degree, but each of the at least two live video streaming cameras must provide some amount of data distinct from another camera. The term ‘streaming’ includes stepwise capture of time consecutive images, a procedure used to minimize amounts of stored image data volume. The cameras are preferably digital camera with a capability of at least 512 pixels/inch (ppi). There are numerous commercially available cameras that satisfy this requirement.
B. A feed from the cameras to a central processor;

The central processor may be located within the same building as the gaming facility or may be distally located. Casinos typically have central computers used for data retention. Communication links carrying the feed to the central computer (processor) may be wired, cabled, Wi-Fi transmissions or combinations thereof.
C. At least two audio transmission-reception devices providing audio feed into the central processor;

The term “audio transmission-reception” is defined herein as including both human entered verbal commands by voice, and human entered verbal commands by keyboard strokes, touchscreen entry or fingering of keyboards.
D. At least one of the at least two audio transmission-reception devices dedicated to a first pre-authorized casino personnel on a game floor of a casino or having a view of the game floor through at least one of the live video stream cameras;

These pre-authorized casino personnel include, but are not limited to pit workers, pit bosses, surveillance operators receiving visual feed from at least one of the at least two audio transmission-reception devices, dealers, security guards, managers, cashiers and the like. These devices are dedicated by use of biosecurity components, including at least one of voice recognition, facial recognition, fingerprints, and retinal scanning. Coded passwords may be used together with or separately from the biosecurity components. By using facial recognition, even though players typically use a players card and the dealer or pit boss swipes the card when the player sits down and then they swipe once again when the player leaves the table. This time of play is used to assess the players rating or value. With facial recognition applied to our camera location, it is possible to eliminate the need for players cards altogether. No more swiping cards would be needed to log the playing time for players.
E. The at least one of the at least two audio-transmission-reception devices being fed into the processor is interpreted by the central processor through execution of Large Language Model software, which Large Language Model software converts words spoken by the authorized casino personnel into digital commands to be executed by the central processor;
F. The central processor is configured to respond to at least one digital command converted from the at least one audio feed from the at least one of the at least two audio transmission reception devices dedicated to a first pre-authorized casino personnel as converted by the Large Language Model into a digital command by performing at least one action selected from the group consisting of retrieving content of:

Large language models are the algorithmic basis for chatbots like OpenAI's ChatGPT and Google's Bard. The technology is tied back to billions—even trillions—of parameters that can make them both inaccurate and non-specific for vertical industry use. Here are examples of what LLMs are and how they work in the current system.

ChatGPT made mainstream the idea that generative artificial intelligence (genAI) could be used by companies and consumers to automate tasks, help with creative ideas, and even code software.

If you need to boil down an email or chat thread into a concise summary or more understandable command, a chatbot such as OpenAI's ChatGPT or Google's Bard can do that. If you need to clarify commands that have been abbreviated, AI can help. For example, if an eye-in-the-sky observer states “chip activity, table 27, seat 4,” the LLM may convert the statement to “The player at seat 4 on table 27 has been detected in movements associated with anomalous chip or betting activity. Isolate images from cameras viewing chip activity.” This is a much more instructive command, and the LLM can be trained, programmed or heuristically educated in the specificity of its commands.

ChatGPT stands for chatbot generative pre-trained transformer. The chatbot's foundation is the GPT large language model (LLM), a computer algorithm that processes natural language inputs and predicts the next word based on what it's already seen. Then it predicts the next word, and the next word, and so on until its answer is complete. With field-of-use specific systems, training and implementation of specific language improvements, especially with respect to commands, can be improved over time and usage.

Along with OpenAI's GPT-3 and 4LLM, popular LLMs include open models such as Google's LaMDA and PaLM LLM (the basis for Bard), Hugging Faces BLOOM and XLM-ROBERTa, Nvidia's NeMo, XLNet, Co:here and GLM-130B.

Open-source LLMs are gaining traction, enabling a cadre of developers to create more customizable models at a lower cost. Meta's launch of LLaMA (Large Language Model Meta AI) kicked off an explosion among developers looking to build on top of open-source LLMs.

Google's new PaLM 2 LLM, announced earlier this month, may use almost five times more training data than its predecessor of just a year ago—3.6 trillion tokens or strings of words. The additional datasets allow PaLM 2 to perform more advanced coding, math, and creative writing tasks.

An LLM is basically a machine-learning neuro neural network trained through data input/output sets. Frequently, the text is unlabeled or uncategorized, and the model is using self-supervised or semi-supervised learning methodology. Information is ingested, or content entered, into the LLM, and the output is what that algorithm predicts the next word will be. The input can be proprietary corporate data or, as in the case of ChatGPT, whatever data it's fed and scraped directly from the internet.

Training LLMs to use the right data may sometimes require the use of massive, expensive server farms that act as supercomputers. The focused and narrow field of casino security (financial and physical) will require specific, but relatively modest input of base data upon which to make assessments of language and interpretation of command results.

LLMs are controlled by parameters, as in millions, billions, and even trillions of them. (Think of a parameter as something that helps an LLM decide between different answer choices.) OpenAI's GPT-3 LLM has 175 billion parameters, and newer models have over one trillion parameters.

While most LLMs, such as OpenAI's GPT-4, are pre-filled with massive amounts of information, prompt engineering by users can also train the model for specific industry or even organizational use. This would be the case within the gaming environment. Playing card content (and evaluating results in specific games) would be fairly simple, and such non-LLM systems can be easily integrated into and used in parallel with the LLM system components of the present field of use, with LLM clarifying any issues within the older systems. Prompt engineering is the process of crafting and optimizing text prompts for an LLM to achieve desired outcomes. Because prompt engineering is a nascent and emerging discipline, enterprises are relying on booklets and prompt guides as a way to ensure optimal responses from their AI applications.
F. The central processor is configured to respond to the digital commands by performing at least one action selected from the group consisting of retrieving content of:
i. Retrieving specific fields of view from the at least two live video streaming cameras based on time intervals identified in the words spoken by the authorized casino personnel;

Each field of view will likely be identified as providing data that requires execution of specific software to respond to commands of analytical activity on that data. For example, a live video feed directed at playing cards and/or chips would not access facial recognition or biosecurity programs, but would be directed towards playing card reading, playing card hand evaluation, game rule content, playing card fraud detection, chip fraud detection and other software to be executed to implement specific system objectives.
ii. Retrieve video frames from the at least two live video streaming cameras as identified in the words spoken by the authorized casino personnel;

The retrieved frames, as suggested directly above, would be reviewed by execution of software analyzing anomalous activity within the specifically identified fields. This analysis could be simplified by a command indicating through LLM “counterfeit chip analysis,” “marked card analysis,” “chip count variation,” and “card position variation” in the command for review of the field of view. The include unauthorized chip replacement, removal, and exchange.
iii. Retrieve an audio feed from one of the audio transmission-reception devices which is not dedicated to the first pre-authorized casino personnel;

This can be a highly varied analytic source. Audio feed may be from security devices positioned within the casino to retrieve conversations at gaming tables to provide evidence in later actions. These would not necessarily be commands, but would be information gathering. For example, a pit boss at a carps table could secondarily collect conversations among players. The device could be activated to initiate such an activity when instructed to do so by the pit boss, as upon his noting an increased amount of tension between particular players. This could also supplement directions from the pit boss to have cameras focus on particular individuals at a specific time, and to have those images flagged/identified as being of potential future significance.
G. The central processor receiving digital commands in addition to actions i), ii) and iii) which requires access to content retrieved from actions i), ii) and/or iii) and analyzing the content to determine anomalous behavior of persons or apparatus within the at least two live video streaming cameras and/or the audio feed from one of the audio transmission-reception devices which is not dedicated to the first pre-authorized casino personnel.

Software and processes already know in the art for analyzing individual behavior, and subsequently identifying anomalous behavior may be used within the present system. An example of such software is provided in U.S. Pat. No. 9,448,636 (Balzacki) using gesture analytic software. Anomalous behavior may be clearly defined by parameters provided to the central processor, such as a combination of a broad, sweeping, attention-deflecting gesture while one hand is controlling gaming chips at a wagering location.

The at least two live video streaming cameras having non-identical fields of view are selected from the group consisting of cameras installed on a gaming table, cameras installed on a support adjacent to or attached to a gaming table, eye-in-the-sky cameras attached to walls and/or ceilings, and rotating movement cameras installed above a plane of the surface of a gaming table. There is substantial art and commercial products in these specific categories.

The feed to the central processor from the at least two live streaming cameras provides facial data of persons within the fields of view from the at least two live streaming cameras, and the central processor is configured to execute facial recognition software on data fed from the at least two live streaming cameras. Non-limiting examples of such useful software is included within U.S. Pat. Nos. 9,639,740; 11,756,334; and U.S. Patent Applications Ser. Nos. 20140016387; and 20210240808. These references are incorporated in their entirety herein by reference. The system may have the facial recognition software compares the fed facial data of persons within the field of view to a library of facial data stored in memory identifying at least one library of facial images including members of personal classes selected from the group consisting of criminals, blacklisted players and terrorists.

The at least one of the at least two audio transmission-reception devices may be selected from the group consisting of a) a processor and keyboard; b) voice receiving and signal transmitting device; and c) a combination of a) and b). Alternative data entry systems may also be used.

The system may have the processor configured to execute voice recognition software upon receiving a voice signal, and the system responding to any command in the voice signal only after the received voice is recognized.

The system may have the processor and keyboard configured with at least one security function selected from the group consisting of voice recognition, facial recognition, bio-recognition, password protection, and security question clearance.

The system may be limited to implementation of any commands issued from one of the at least two audio transmission-reception devices that requires overt security actions against any player within the casino, such that activity in response to a command must be seconded by a second one of the at least two audio transmission-reception devices and the system is configured such that such command will be implemented only upon confirmation of authority of the second one of the at least two audio transmission-reception devices. For example, if one pre-authorized personnel suspects a security violation that might require police intervention, such a command will not be active until a second approval by a second pre-authorized personnel.

A method for overseeing security at a gaming facility on a system as described herein may include (with the apparatus/system components clarified above):
A. At least two live video stream cameras having non-identical fields of view;
B. A feed from the cameras to a central processor;
C. At least two audio reception devices providing audio feed into the central processor;
D. At least one of the at least two audio reception devices dedicated to a first pre-authorized casino personnel on a game floor of a casino or having a view of the game floor through at least one of the live video stream cameras;
E. The at least one of the at least two audio transmission-reception devices being fed into the processor is interpreted by the central processor through execution of Large Language Model software, which Large Language Model software converts words spoken by the authorized casino personnel into digital commands to be executed by the central processor;
F. The central processor is configured to respond to at least one digital command converted from the at least one audio feed from the at least one of the at least two audio transmission-reception devices dedicated to a first pre-authorized casino personnel as converted by the Large Language Model into a digital command by performing at least one action selected from the group consisting of retrieving content of:
iv. Retrieving specific fields of view from the at least two live video stream cameras based on time intervals identified in the words spoken by the authorized casino personnel;
iv. Retrieving video frames from the at least two live video stream cameras as identified in the words spoken by the authorized casino personnel;
iv. Retrieving an audio feed from one of the audio transmission-reception devices which is not dedicated to the first pre-authorized casino personnel;
the central processor receiving digital commands in addition to actions i), ii) and iii) which requires access to content retrieved from actions i), ii) and/or iii) and analyzing the content to determine anomalous behavior of persons or apparatus within the at least two live video streams and/or the audio feed from one of the audio reception devices which is not dedicated to the first pre-authorized casino personnel;
wherein the method comprising storing feed from the at least two live video stream cameras having non-identical fields of view into memory accessible by the central processor;
G. the central processor executing software to retrieve content of:
vii. specific fields of view from the at least two live video stream cameras based on time intervals identified in the words entered by the authorized casino personnel;
vii. video frames from the at least two live video stream cameras as identified in the words entered by the authorized casino personnel; and
vii. a feed from one of the audio transmission-reception devices which is not dedicated to the first pre-authorized casino personnel; and
H. The central processor identifying at least one instance of anomalous activity observed in response to analysis of content from i), ii) and/or iii) after response to the at least one digital command converted from the at least one feed from the at least one of the at least two audio transmission-reception devices dedicated to a first pre-authorized casino personnel as converted by the Large Language Model into a digital command.

The method may be practiced where the at least two live video streaming cameras having non-identical fields of view are selected from the group consisting of cameras installed on a gaming table, cameras installed on a support adjacent to or attached to a gaming table, eye-in-the-sky cameras attached to walls and/or ceilings, and rotating movement cameras installed above a plane of the surface of a gaming table, and the at least two live streaming cameras feed data in real time to the central processor where the feed is stored in memory.

The method may be practiced wherein feed to the central processor from the at least two live streaming cameras provide facial data of persons within the fields of view from the at least two live streaming cameras, and the central processor is configured to execute facial recognition software on data fed from the at least two live streaming cameras.

The method may be practiced wherein the facial recognition software compares the fed facial data of persons within the field of view to a library of facial data stored in memory identifying at least one library of facial images including members of personal classes selected from the group consisting of criminals, blacklisted players and terrorists, and upon having a baseline match of fed facial data of persons within the field of view to an individual within the at least one library, an alert is sent through the system indicating that such a baseline match has been made, and identifying in the alert a location of the person within the field of view that caused the alert.

The method may be practiced wherein commands are directed to the central processor from the at least one of the at least two audio transmission-reception devices which are selected from the group consisting of a) a processor and keyboard; b) voice receiving and signal transmitting device; and c) a combination of a) and b). The method may be practiced wherein the processor executes voice recognition software upon receiving a voice signal, and the system responds to any command in the voice signal only after the received voice is recognized.

The method may be practiced wherein the processor and keyboard executes at least one security function selected from the group consisting of voice recognition, facial recognition, bio-recognition, password protection, and security question clearance before a command from the processor and keyboard is acted upon.

The method may be practiced wherein a command issued from one of the at least two audio transmission-reception devices that requires overt security actions against any person within the casino, such activity in response to a command is seconded by a second one of the at least two audio transmission-reception devices and the system implements that command only upon confirmation of authority of the second one of the at least two audio transmission-reception devices.

The method may be practiced wherein the processor and keyboard executes at least one security function selected from the group consisting of voice recognition, facial recognition, bio-recognition, password protection, and security question clearance.

Further discussion of events executed by the system in the practice of the invention include

### 1. Camera Feeds→Frames

Multiple cameras (able to scale to every camera deployed in a casino) capture live video streams.
Frames are sampled or split out for processing (e.g., 30 FPS down-sampled to 15 FPS, or triggered on certain events).
   2. User Interactions with the LLM (Large Language Models) Agent
The user (e.g., a pit manager or security team) provides text-based or voice-based instructions to the “LLM Agent.” Examples:
   “Identify the highest bet on Blackjack Table #2 in the past 30 minutes.”
   “Run facial recognition on camera #5 to see if a known banned individual is present.”
   “Quickly highlight any suspicious crowd movement near the entry doors.”

### 3. LLM Agent→Decision Logic

1. Check if the user request is covered by an existing custom model with high specificity.
   If yes, the LLM Agent invokes that specialized vision model from the “Custom Model Library.”
   If not, the user can request the EagleSight team to build a new custom model trained on relevant data for that specialized task.
2. If the user request is general (and does not demand very high accuracy) or a known VLM can handle it, the LLM Agent instructs the VLM to perform the task.

### 2. Vision Outputs→Eaglesight DB

1. Results from either the custom model or the VLM pipeline are stored (or updated) in the Eaglesight database.
2. The LLM Agent can then retrieve these results, perform further reasoning, generate insights, or respond to user queries in a natural language format.

### 3. LLM Agent↔VLM↔DB

1. The LLM Agent can query the Eaglesight DB for historical or real-time data (e.g., bet amounts, card detections, movement flags).
2. The VLM can process new frames if asked to do an on-the-fly vision task.
3. Finally, the LLM Agent synthesizes everything into a text-based or structured answer for the user.

### LLM Agent in Detail

### 1. Natural Language Parsing

The LLM agent receives the user's instruction in free-form language either voice or text.
It uses internal “prompt engineering” or fine-tuned context to interpret the user's intent (e.g., “detect specific object,” “analyze historical data,” “generate real-time alerts”).

### 2. Task Dissection

The LLM breaks down the user request into subtasks. For instance:
   “Identify all suspicious behaviors near slot machines 1-5 from 2 PM to 3 PM.”
   Subtasks might be:
      1. Retrieve relevant video frames from camera feeds near slot machines #1-5.
      2. Check if the user wants a general motion/loitering detection (handled by the VLM) or a specific model (e.g., a custom model for detecting known cheat behaviors).

### 3. Decision Path

Check the Custom Model Library:
   If there is a specialized “loitering detection model” or “chip angle detection model,” the LLM can invoke it.
Fallback to VLM:
   If no specialized model exists or if the user simply wants a quick, general detection, the LLM uses the VLM with a suitable text prompt (e.g., “Find people standing still for more than 10 seconds.”).

### 4. Post-Processing & Explanation.

Once the model(s) return results—say, bounding boxes of individuals or anomalies detected—the LLM Agent can:
   Cross-reference these results with database records (e.g., known blacklisted players, historical logs, time-of-day stats).
   Generate a natural-language narrative or a summarized report. For instance, “Between 2:15 PM and 2:20 PM, three individuals loitered in front of slot machine #3 for an average of 4 minutes each.”

When an incident or activity is identified by the central processor, staff is immediately notified in real-time, enabling them to consistently prevent and mitigate harmful events, such as: Active Shooter, Intruders, Assault, Fights/Conflicts, Falls/Drowning, Sexual Harassment, Sex Trafficking, Missing Persons, BOLOs, Intoxication and/or Underage Participation.

Although this document focuses on gaming environments, the system, absent its focus on gaming elements such as cards, dice, chips, and cash, can be used to monitor physical safety and events at other venues, such as schools, churches, playgrounds, manufacturing plants, condominiums, apartments and the like.

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

A system or method is provided for monitoring real-time gaming activities of one or more users/players (hereinafter, the terms “player” and “user” are used interchangeably) playing a game.

In one or more embodiments, the system for monitoring real-time gaming activities may comprise at least one processor, at least one memory operatively connected to said processor, and a plurality of sensing modalities, the sensing modalities being configured to capture a representation of a gaming area of a game and operatively connected to said processor (hereinafter, “the System”).

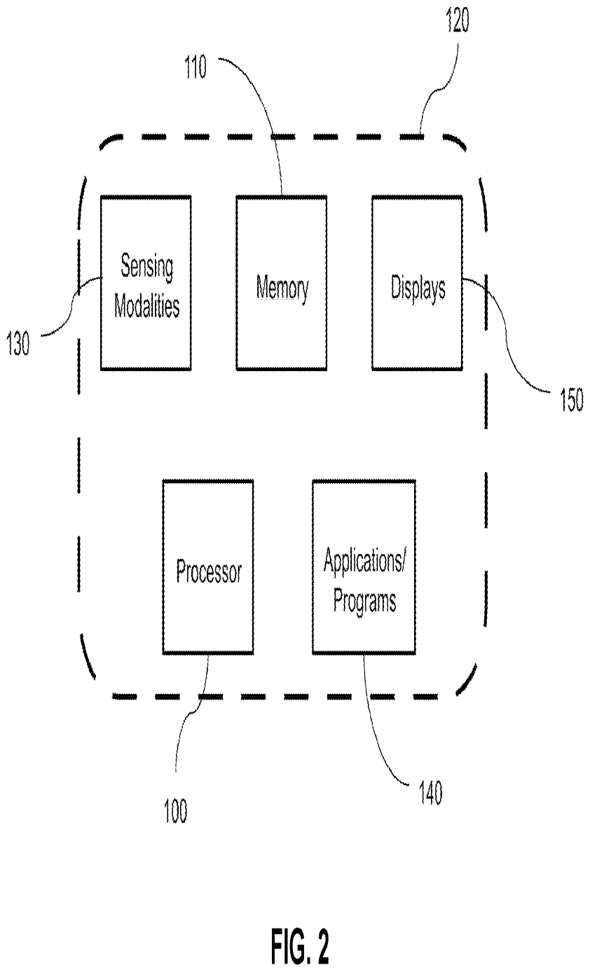

In an illustrative example, and referring to FIG. 2, the System may comprise a processor 100, a memory 110, a network 120, a plurality of sensing modalities 130, one or more applications/programs 140, and one or more displays 150 wherein the processor 100, the memory 110, and sensing modalities 130 may be physically located within the same local space or one or more of these elements (e.g., 100, 110, 130 and 150) may be located in different areas/spaces.

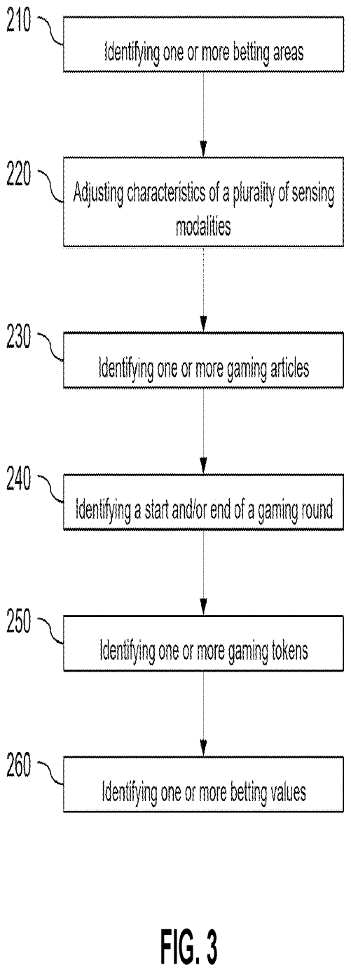

In one or more embodiments, referring to FIGS. 2 and 3, a method for monitoring real-time gaming activities of one or more players is provided. The method may be performed by the System. First, the System may identify one or more betting areas, for example, based on data captured via the sensing modalities 130. Second, the System may adjust characteristics of the plurality of sensing modalities, for example, based on data captured via the sensing modalities 130. Third, the System may identify one or more gaming articles, for example, playing cards, Fourth, the System may identify a start and/or end of a gaming round, for example, a gaming round of a game such as poker, blackjack, and the like. Fifth, the System may identify one or more gaming tokens, for example, casino chips such as poker chips, and the like. Sixth, the System may be configured to identify/calculate betting values corresponding to the players, for example, the betting values of casino chips. The sensing modalities, such as the sensing modalities 130, may be configured to capture a plurality of representations corresponding to the gaming area of a game. The plurality of representations may comprise one or more images (e.g., video frames) or video sequences of the gaming area captured by the sensing modalities, for example, one or more cameras. The gaming area may comprise an entire physical area of the game (e.g., the entire poker table, etc.).

With respect to the first step of identifying betting areas, the System may be configured to employ two methods: an object detection model-based method and a marker detection method. In one embodiment, the System may be configured to switch between these two methods based on predefined criteria or real-time assessments. For example, if lighting conditions change or table design/layout changes, one method may be more suitable to use than the other. The marker detection method is less susceptible to variations in table layouts or betting area appearances as the method relies on the markers that are physically fixed to certain parts of a game table. The marker detection method is configured to provide precise localization of betting areas, even in challenging lighting conditions. The marker detection method is also computationally efficient, aiding real-time processing. In contrast, the object detection model-based method is configured to provide more flexibility as it is effective in environments where betting areas have unique designs or are subject to change. Also, the object detection model-based method does not require physical markers on the game table such that the aesthetic integrity of the gaming environment may be maintained. In another embodiment, the System may be configured to switch between these two methods if one method fails or provides low confidence. In one embodiment, the System may be configured to automatically utilize the alternative method to ensure continuous accurate detection of the betting areas.

In one embodiment, the object detection model-based method may employ one or more artificial intelligence (AI) models that are configured to detect, recognize, or identify an object based on an image or video. In one embodiment, such an AI model may be a Yolo model or the like. In this embodiment, the sensing modalities may comprise cameras that are configured to capture video/image frames in real-time. The cameras may be configured to apply frame sampling to optimize processing time (e.g., processing every Nth frame).

The AI model (e.g., the Yolo model) may be trained specifically to recognize or identify betting areas. In one embodiment, training data for the AI model may comprise images/video sequences of the betting areas (e.g., betting boxes on a game table). These images may be taken for purposes of training the AI model. These images may be annotated or labelled by creating a mask around each betting box. These images may further be augmented, e.g., create multiple versions of each image with varying hue or saturation settings. The augmented images are designed to provide richer/diverse training data that embodies variables such as lighting conditions and different game table environments. With these augmented images, the AI model is generalized to perform better in real scenarios. In one embodiment, the augmentation of training data may comprise horizontal flipping, varying zoom levels, changing exposure between-10% and +10%, and blurring up to 2.5 px.

A typical game table includes a plurality of betting areas that are having a geometric shape. The visual objective masks are formed on top of the betting areas with different, identifiable colors. For example, a first mask may be red and formed on top of the first betting area. A second mask may be green and formed on top of the second betting area. Each betting area may be defined by coordinates. In one embodiment, four coordinates may be used to define a betting area or a mask. For example, the first mask (or the underlying betting area) may be defined by four coordinates, P1, P2, P3, and P4, as is typical in positional mapping. In one embodiment, the coordinates may comprise three dimensional coordinates, e.g., X, Y, and Z.

After training, the AI model may be used to detect or identify the betting areas in real world settings. The sensing modalities (e.g., cameras) capture video feeds from a game table. In one embodiment, at least two cameras are used to capture the video feeds. At least two or more cameras may be used so that multiple angles of the gaming area may be captured, thereby allowing for a more accurate identification of the betting areas. The cameras may be positioned and/or oriented in any position suitable for capturing video feeds of the gaming area. In one embodiment, the camera positions may include positioning at least one of the cameras above the gaming area and/or positioning at least one of the cameras diagonal to the gaming area.

In one embodiment, representations of the gaming area captured by the plurality of sensing modalities, such as the video feeds captured by the cameras, may be transmitted to a memory and/or database that is part of the System and/or located in a different part of the casino. For example, the video feeds captured by the cameras may be transmitted to the same memory where the AI model is stored, which may collectively be part of the same System. In another example, the video feeds may be transmitted to a memory located in a different part of the casino that is separate from the System, while the AI model is stored in a memory that is part of the System. In this way, the video feeds captured by the cameras, which correspond to input data for the AI model, may be stored in the same location as or separately from the AI model, thus allowing for more robust configurations of the System (e.g., camera placement, memory placement, etc.).

The AI model may receive input data from the System. In one embodiment, the input data represents the frames from the video feeds captured by the cameras. The frames may include the whole game table. In one embodiment where the Yolo model is implemented, the frames may be resized to Yolo input dimensions (e.g., 640×640), containing the entire game table. In other embodiments where different AI models are implemented, the frames may be resized to fit into the dimensions suitable for those models.

The AI model may be configured to analyze the input data. The AI model is configured to detect or identify each betting area/box in the game table based on the input 20 data. The AI model is configured to generate the four coordinates of each betting area/box. Each identified betting area/box may be associated with a player, e.g., the first betting area is associated with a player who is playing on the first betting area. Each player and his or her associated betting area may be assigned with a number. In one embodiment, after analyzing the input data, the AI model may be configured to generate output (or output data). The output data may represent bounding boxes identifying the betting areas, including the four coordinates (e.g., x_min, y_min, x_max, y_max), class labels, and confidence scores.

In one embodiment, the class labels may represent the type of object (e.g., betting areas, playing card, gaming chips, person, etc.) that the AI model is configured to detect. The class labels may comprise an index value (e.g., numeric values, etc.) corresponding to the object that the model is configured to detect. For example, the AI model may identify the betting areas corresponding to the players, and associate a first class label with the betting areas, wherein the first class label may comprise a first index value that corresponds to the betting areas. In other examples, and as further described herein, the AI model may be configured to identify one or more gaming articles, for example, playing cards corresponding to the players. In this case, the AI model may associate a second class label with the gaming articles, wherein the second class label may comprise a second index value corresponding to the gaming articles.

In one embodiment, the confidence score may represent the likelihood that the detected object accurately corresponds to the class label associated by the AI model. The AI model may determine a confidence level based on the associated class and a pre-defined list of correct class labels. The confidence score may comprise a numeric value between 0 and 1. For example, the AI model may determine a confidence score of 0.56 that a betting area accurately represents the area used by a player for betting, wherein the confidence score of 0.56 represents a 56% likelihood of accuracy.

In one embodiment, the System may be configured to apply a buffer/crop area around the coordinates of the betting areas for each player. The buffer/crop area may become a detection frame or Region of Interest (ROI) for the player who is associated with that buffer/crop area. The buffer/crop area may be different for each player depending on the distance from the camera(s). In one embodiment, a single ROI is assigned for each betting area per player. The System may be configured to automatically update ROIs based on the detected betting area positions. The ROIs may be further used by other AI models for subsequent steps, as described below.

In another embodiment, the System may be configured to detect, recognize, or identify betting areas that are having different or custom shapes (e.g., not in a rectangular shape). In this embodiment, the System may be configured to re-train the AI model with new training data obtained from the cameras. The new training data may comprise images or video sequences of a game table having betting areas with different or custom shapes. A mask is formed on each betting area. Instead of generating the four coordinates, the System may be configured to generate a three-dimensional training data: (H*W*Class).

For example, “H” and “W” may represent the location of each pixel in two dimensions (height 15 and width). “Class” may represent whether or not the pixel belongs inside the betting area. For example, if a particular pixel in the image is located outside of the betting area, then “Class” may be labeled as “0” while if the pixel is located inside of the betting area, then “Class” may be labeled as “1.” These are provided only as an example, and any other suitable labeling or designation may be utilized instead of using “1” and “0.” With the three-dimensional training data, each pixel is classified to be located either inside the betting area or outside the betting area. After training, the newly trained AI model may be used to detect or identify the betting areas having different or custom shapes in real world settings, in the similar manner as described above with respect to the rectangular-shaped betting areas.

In one embodiment, the System may be configured to detect, recognize, or identify betting areas having different or custom shapes corresponding to the same gaming area, for example, physically located on the same game table. For example, the System may detect a first betting area having a box shape and detect a second betting area having a triangular shape. In this case, a first AI model of the one or more AI models may identify the first betting area, and a second AI model of the one or more AI models may identify the second betting area. The first AI model may be trained on training data corresponding to the shape of the first betting area, a box shape, and the second AI model may be trained on training data corresponding to the shape of the second betting area, a triangular shape. In this way, the System may identify betting areas having different or custom shapes within the same gaming area, allowing for greater accuracy and versatility in identifying the betting areas of a game.

Although the Yolo models are described above as one of the embodiments of the present disclosure, it should be apparent that any other AI model suitable to detect the betting areas based on the images or video sequences of a game table may also be implemented in the System.

In one embodiment, the marker detection method may employ one or more Aruco markers (or any other suitable fiducial markers) placed discreetly on a game table to detect betting areas. Markers/tokens/chips/coins are typically placed inside the table edge, out of the view of the players. Alternatively, the markers may be placed in other locations of the table suitable for detecting the betting areas. Input data for the marker detection method may be configured to be the same form of data as the object detection model-based method, e.g., the frames from the video feeds covering the whole game table. The input data may comprise the video frames including the markers. In one embodiment, a marker detection algorithm may be employed, such as OpenCV's Aruco module, to detect markers and calculate their positions. For example, the marker detection algorithm may identify the positions of the markers with respect to the positions of the one or more cameras, for example, in a three-dimensional space. Based on the identified positions of the markers, the System may identify a coordinate system, such as a coordinate system comprising three vectors.

After that, the ROIs for the betting areas may be defined based on the detected marker positions, such as their relative positions to the markers, and the representations captured by the sensing modalities, such as video feeds captured by the one or more cameras. For example, the System may define ROIs. In one embodiment, like the output of the object detection model-based method, in the marker method, the System may be configured to generate the same form of output, e.g., output data representing bounding boxes identifying the betting areas including the four coordinates (e.g., x_min, y_min, x_max, y_max), class labels, and confidence scores. By having the same input and output format, the System may be configured to interchangeably use the object detection model-based method and the marker detection method.

Although the marker detection method is described above as one of the embodiments of the present disclosure, it should be apparent that any other suitable method (e.g., using fiducial markers) may also be implemented in the System.

With respect to the first step of identifying betting areas, the System provides certain advantages and benefits, in addition to the feature of switching between the object detection model-based method and the marker detection method. For example, once the betting area coordinates are defined, the System may be configured to use those coordinates as “anchor points” to automatically mitigate potential camera displacement. The betting area boxes may also be used to determine the size of frames for downstream models (e.g., the other AI models utilized in subsequent steps as described below). Moreover, the frames may be dynamically scaled based on the distance of the player/betting area. Finally, each detected betting area (e.g., 6-7 areas) may be used to segment the overall frame into individual cropped frames, capturing each player's betting activity independently.

In one embodiment, one or more of the AI models and the marker detection method described herein may be configured to be operated by one or more computer applications/programs (e.g., 140 of FIG. 2). In this embodiment, the processor 100 may be configured to access the applications/programs either locally or remotely to control the operation of the AI models and the marker detection method.

In another embodiment, the detection of the betting areas may occur at a predefined temporal interval. For example, the System may be configured to detect the betting areas between each round, or at any other suitable time intervals.

In another embodiment, one or more of the AI models may be selected and/or trained based on the casino that the System is implemented on and/or conditions impacting the casino environment (e.g., lighting, felt/betting box design, etc.).

### Interchangeability and Adaptation—

With respect to the second step of adjusting the sensing modalities, the System may be configured to contemporaneously and/or at pre-defined intervals adjust the characteristics of the sensing modalities based on at least one of predefined criteria and/or real-time assessments.

In one embodiment, the System may be configured to contemporaneously and/or at pre-defined intervals adjust the parameters of the sensing modalities (e.g., the cameras, etc.) based on real-time assessments of conditions impacting the capturing of the images and/or the identification of the betting areas, such as lighting conditions, ambient temperature conditions, humidity conditions, occlusions, etc. These conditions define the characteristics/conditions of each ROI or betting area detected by the AI model (e.g., Yolo model or the like) that may affect the performance of the sensing modalities. In one embodiment, the parameters of the sensing modalities (e.g., cameras) may comprise, focus, zoom, exposure, white balance, camera angle, image resolution etc. Based on the measured characteristics/conditions of the ROI/betting area, the System may be configured to adjust the parameters of the sensing modalities. For example, the System may adjust parameters of the sensing modalities (e.g., cameras) in response to high or low lighting conditions such that the betting area is accurately detected. In another example, the System may adjust characteristics of the sensing modalities in response to detection of occlusions, e.g., presence of any obstacle including a person, gaming articles, stacks of gaming tokens, etc., blocking a clear view of the betting area or the like. The parameters such as exposure, white balance, etc. may be adjusted to more accurately capture an image/video of the betting area based on the conditions of the ROI.

In another embodiment, if any occlusion condition is detected, then the System may be configured to flag that condition and pause the process of identifying the betting areas. In this embodiment, the System may be configured to pause the identifying process until an updated image/video of the betting areas is recaptured by the sensing modalities and/or received by the System. In one embodiment, when updated images/videos of the betting areas are received by the System, then the AI model may be configured to update the ROIs/betting boxes based on the updated images/videos.

In one embodiment, the System may be configured to contemporaneously and/or at pre-defined intervals adjust the parameters of the sensing modalities based on real-time assessments of conditions impacting the plurality of sensing modalities (e.g. cameras, etc.) operatively connected to the system, such as calibration, image resolution, shooting distance, etc. For example, the System may adjust characteristics of the sensing modalities based on a real-time assessment that the cameras operatively connected to the system are not calibrated. In another example, the System may adjust characteristics of the sensing modalities based on a real-time assessment of the image resolution of the cameras, so as to ensure that the betting areas are accurately identified even if the image resolution changes, for example, due to usage degradation etc. In a further example, the System may adjust characteristics of the sensing modalities based on a real-time assessment of the 10 shooting height of the camera, so as to ensure that the betting areas are accurate identified even if the position(s) of the cameras changes with respect to the gaming area of the game.

In one embodiment, the System may be configured to contemporaneously and/or at pre-defined intervals adjust the characteristics of the sensing modalities, such as the operatively connected cameras, based on at least one of the predefined criteria and/or the real-time assessments of the capturing of the images and/or the identification of the betting areas. For example, the System may adjust characteristics of the cameras such as location, shutter speed, aperture, amongst others, to ensure that the betting areas are accurately identified by the AI model.

In one embodiment, the System may be configured to adjust the physical position(s) and orientation(s) (collectively referred to herein as “position(s)”) of the cameras based on a real-time assessment of the present position(s) of the cameras. For example, the System may adjust the position(s) of the cameras to optimized position(s) upon a determination that the present position(s) are deficient based on the real-time assessments. The optimized position may represent position(s) of the cameras that is optimized for capturing the images corresponding to the input data so as to ensure that the AI Model accurately identifies the betting area based on the input data.

In one embodiment, the System may be further configured to adjust the shutter speed of the cameras in response to high or low lighting conditions. For example, the System may increase the shutter speed in high lighting conditions and decrease the shutter speed in low lighting conditions. The shutter speed may be contemporaneously changed based on the real-time assessment of the lighting conditions, to ensure seamless and accurate identification of the betting boxes.

In one embodiment, the System may be configured to selectively perform real-time assessments of the capturing of the images and/or the identification of the betting areas. For example, the System may selectively allocate processing power of the processor to perform a specific real-time assessment, such as the real-time assessment of the position of the cameras in response to a determination that the position of the cameras affects the accuracy of betting area identification. In another example, the System may selectively allocate the processing power to perform a different real-time assessment, such as the realtime assessment of lighting conditions in response to a determination that the lighting conditions affects the accuracy of betting area identification. In this way, the System is able to direct processing power to one or more specific real-time assessments that have a greater effect on the betting area identification, thus optimizing even if varying physical conditions are present.

In one embodiment, the System may be configured to adjust the parameters of the sensing modalities between each round of a game. For example, the pre-defined temporal interval for detecting the conditions of the ROIs and adjusting the parameters of the sensing modalities may be configured to be between each round, or any other suitable time intervals.

In another embodiment, the System may adjust the parameters of the sensing modalities via a control signal, wherein the control signal is sent by the System to adjust the parameters. In the case that parameters of the sensing modalities are adjusted via the control signal, the System may not require manual adjustment for adjusting the parameters, such as the physical adjustment of the parameters by casino staff. However, the System and the sensing modalities may be configured to allow for manual control. For example, the System may communicate its determination that the sensing modalities are to be adjusted to casino staff, wherein the casino staff may manually adjust the sensing modalities via physical controls (e.g., physical controls located on the cameras, etc.) in response. In some cases, the System may adjust the sensing modalities via the control signal and via manual control.

Identification of Gaming Articles With respect to the third step of identifying one or more gaming articles, the System may be configured to identify the gaming articles (e.g., playing cards, etc.) corresponding to the one or more players playing the game via one or more AI models. In one embodiment, the AI models may comprise the Yolo model. For example, if the gaming articles comprise playing cards, the System may be configured to identify the playing cards. Although the Yolo models are described as one of the embodiments of the present disclosure, it should be apparent that any other AI model suitable to detect or identify the gaming articles based on the images or video sequences of a game table may also be implemented in the System.

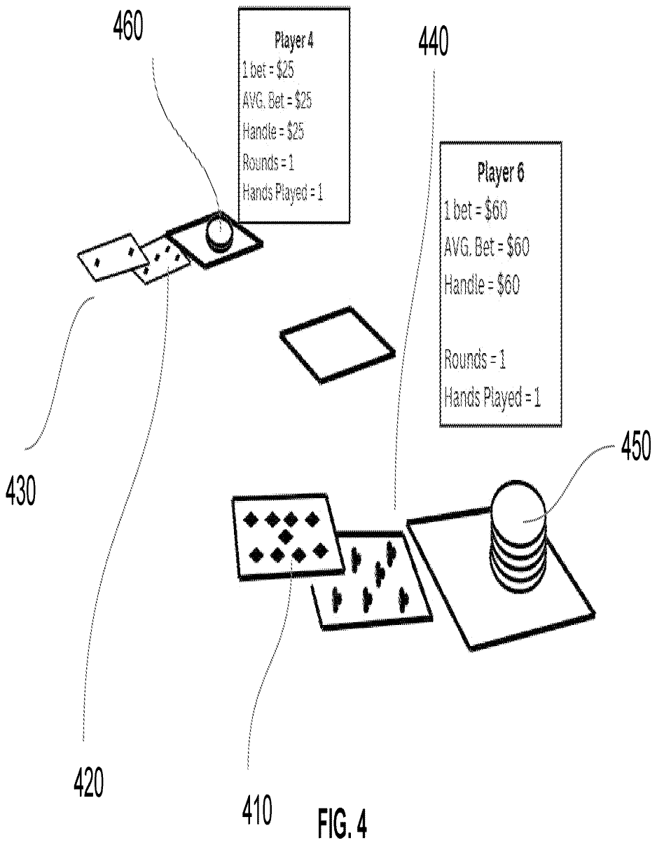

In one embodiment, the System may be configured to identify individual gaming articles, such as the playing cards via the AI model. The AI model may, based on input data including images or video sequences of the gaming area captured by one or more cameras, identify playing cards corresponding to each player. For example, referring to FIG. 4, the System may identify the playing card 410 as corresponding to Player 6 and identify the playing card 420 as corresponding to Player 4.

In one embodiment, the System may further identify one or more unique identifiers corresponding to the gaming area, based on representations of the gaming area captured by the sensing modalities (e.g., cameras, etc.). The System may identify one or more player identifiers respectively corresponding to the one or more players playing the game based on the unique identifiers. For example, the AI model may receive input data, the input data comprising video feeds of the gaming area captured by the cameras. Based on the input data, the AI model may identify a first unique identifier representing a gaming table corresponding to the gaming area. The AI model may then identify a second unique identifier representing the position of a specific player of the one or more players based on the detected betting box corresponding to the player, such as the seat number of the seat that the specific player is occupying. The AI model may, based on at least one of the identified first and second unique identifiers, identify a player identifier corresponding to the specific player, and generate output data corresponding to the specific player. In an illustrative example, during a gaming round, the AI model may identify a first unique identifier corresponding to the gaming table as “Table 3” based on the input data. The AI model may identify a second unique identifier corresponding to the gaming seat used by the player as “Seat 2” based on the input data. The AI model may then identify the timing data corresponding to the start and end of the gaming round, as discussed further herein, as starting from 5 μm and ending at 7 μm on Apr. 12, 2024. The System may associate the first unique identifier, second unique identifier, and the identified times, for example, “table 3, number 2, gaming round starting from 5 μm and ending at 7 μm on Apr. 12, 2024” to determine the player identifier.

In a similar manner, based on the input data, the AI model may determine a betting identifier representing the specific time that a bet was placed by the player (e.g., poker chips being placed, etc.) during the gaming round. The AI model may identify the specific time that the bet was placed, such as “5:24 μm on Apr. 12, 2024” in addition to a third unique identifier corresponding to the gaming table and a fourth unique identifier corresponding to the specific seat that the bet was placed from based on the identified betting areas. Based on the third and fourth unique identifier, and the betting time, the AI model may determine a betting identifier.

The AI model may, identify the player identifier based on at least one of the first and/or second unique identifiers, and/or the identified betting identifier. In this case, the System may compare the first and second unique identifiers with the betting time to determine the player identifier corresponding to the specific player. In this way, the System is able to determine which specific player is making the betting transaction during gameplay, and associate the betting transaction with the player identifier.

In one embodiment, the System may further identify additional gaming articles, such as the playing cards placed on the gaming area (or the whole game table). For example, as additional playing cards corresponding to each player are placed on the gaming area, the System identifies those additional playing cards, and may associate them with the corresponding players.

In one embodiment, the System may determine one or more hands corresponding to the one or more players based on the identified gaming articles, such as the playing cards. The hands represent the gameplay actions taken by the player in furtherance of the game, such as receiving a set of playing cards in a blackjack game or placing a new or additional wager on the betting area. For example, the System may determine a quantity of hands corresponding to each player based on the identified gaming articles corresponding to each player. As the game progresses and new gaming articles are placed on the gaming area, the System identifies further hands corresponding to the players and identifies a new quantity of hands accordingly. The System may reflect this updated quantity via a plurality of operatively connected displays contemporaneously as new gaming articles are placed. In one embodiment, a number of hands (and any other related information) played by each player may be stored on a database as part of each player's player profile or the like. In an illustrative example, and with reference to FIG. 4, the System may identify the hand 430 as corresponding to player 6 and the hand 440 as corresponding to player 4.

In the above embodiments, one or more AI models may be implemented to identify gaming articles. The AI model(s) may be configured as a separate AI model, different from the AI model configured for identifying the betting areas.

In one embodiment, similar to the training data for the AI models configured to identify the betting areas, the training data for the AI model for identifying the gaming articles may comprise augmented training data. For example, the training data may comprise labeled images of the objects (e.g., cards or hands) that need to be detected or segmented. The training data may be pre-recorded with cameras.

### Identification of Gaming Start and End

With respect to the fourth step of identifying a start and/or an end of the game, the System may be configured to identify at least one of the start or the end of a gaming round corresponding to the game via the one or more AI models. In one embodiment, the AI models may comprise the Yolo model. Although the Yolo models are described as one of the embodiments of the present disclosure, it should be apparent that any other AI model suitable to detect or identify the start or the end of a gaming round based on the images or video sequences of a game table may also be implemented in the System. The gaming round may represent any portion of gameplay having at least one of a beginning and/or an end. For example, the gaming round may represent an entire session of gameplay. In this case, the System may be configured to identify when the game starts, i.e., when gameplay by the players begins, and/or when the game ends, i.e., when gameplay by the players ends.

In one embodiment, the System may be configured to identify a start and/or an end of a gaming round, wherein the gaming round represents an in-game round of gameplay. For example, the System may identify a start and/or end of a round of betting by the players during the game. The System may be configured to identify one or more of such in-game rounds of gameplay.

In one embodiment, the System may be configured to identify a start and/or an end of a gaming round corresponding to each of the one or more players. For example, the System may identify a start and/or end of an individual round of betting by a player of the one or more players. The System may be configured to identify one or more of such individual rounds of betting corresponding to each of the one or more players. In this case, the System may identify the start and/or end of a first betting round corresponding to a first player of the one or more players, and identify the start and/or end of a second betting round corresponding to a second player of the one or more players. The System is able to monitor gaming rounds specific to individual players thus allowing for a continuous and accurate analysis of the players' gaming activities, even if players enter or exit during gameplay.

In one embodiment, the System may be configured to identify a start of a gaming round based on characteristics of the one or more gaming articles (e.g., playing cards, etc.). The AI model may, based on the input data, identify characteristics of the playing cards, that represent a start of the gaming round. For example, the AI model may identify that the playing cards are oriented facing upward, i.e., that the side having pips (e.g., hearts, diamonds, spades, clubs, etc.) or numbers/letters face upward. Based on this identification that the playing cards are oriented facing up, the System may identify that the gaming round has started. The System may be configured to identify a start based on any such gaming articles in this manner, and the AI model may identify any relevant characteristics of the gaming articles to identify the start.

In one embodiment, the identification of a start and an end of a gaming round may be configured to cover the entire game table. For example, the System may be configured to detect the entire game table for identifying a start and an end of each round. Alternatively, the System may be configured to selectively detect only a portion or portions of the game table (e.g., each betting area or the like) for purposes of identifying a start and an end of each round.

In one embodiment, the System may be configured to identify an end of the gaming round based on the characteristics of the one or more gaming articles, such as the playing cards. The AI model may, based on the input data, identify characteristics of the playing cards that represent an end of the gaming round. For example, the System may, via the AI model, identify that the playing cards are oriented downwards, i.e., that the side having pips (e.g., hearts, diamonds, spades, clubs, etc.) faces downward and/or is not visible. Based on this identification that the playing cards are oriented facing down, the System may identify that the gaming round has ended.

In one embodiment, the AI model may be trained via a set of training data corresponding to the gameplay of different games, thus allowing the System, via the AI model, to accurately determine the start and/or the end of different games having different gameplay. The AI model may be trained via a set of first training data corresponding to a first game to identify the start and/or end of a gaming round of the first game. The same AI model may then be trained via a set of second training data corresponding to a second game to identify a second start and/or end of a gaming round of the second game. In one embodiment, similar to the training data for the AI models configured to identify the betting areas, the training data for the AI model for identifying a start and an end of a gaming round may comprise augmented data. For example, the training data may comprise labeled images of the objects (e.g., cards or hands) that need to be detected or segmented. The training data may be pre-recorded with cameras.

In one embodiment, the gaming articles corresponding to each of the first game and the second game may comprise the same type of gaming articles, such as playing cards, but have different gameplay rules. Since the gameplay rules of the first game and the second game are different, the AI model will associate the characteristics of the playing cards unique to each of the first game or the second game based on the training data it is trained with. For example, if the playing cards are identified as being oriented face up during the first game, the AI model may determine a start of a corresponding gaming round. However, if the playing cards are identified as being oriented face up during a second game, the AI model may determine an end of a corresponding gaming round.

In one embodiment, the gaming articles corresponding to each of the first game and the second game may comprise different types of gaming articles. In this case, the AI model may be trained with training data corresponding to each of the first game and the second game to recognize a start or an end of a gaming round respectively corresponding to the first game and the second game. For example, the System may, via the AI model, identify a first gaming instrument having a box shape (e.g., a playing card having a box shape, etc.) corresponding to the first game, and identify a start and/or end based on the first gaming instrument. The System may then, via the AI model, identify a second gaming instrument having a triangular shape (e.g., a playing card having a triangular shape, etc.) corresponding to the second game, and identify a start and/or end based on the second gaming instrument.

In one embodiment, the System may be configured to identify a start and/or end 15 of a gaming round based on characteristics of the gaming articles, such as their position. For example, the System, via the AI model, may determine that the position of the playing cards is outside of a pre-defined area, such as the identified betting areas. Based on this determination, the System may identify the end of a gaming round. In the case that the System determines the playing cards are within the betting areas, the System may identify the start of the gaming round based on this determination.

In one embodiment, the System may identify a start and/or end of a gaming round based on the duration of time that the gaming articles, such as the playing cards, are present at the determined position. This duration of time may correspond to one or more time buffers provided by the System. For example, the System may identify the end of the gaming round based on a determination that the playing cards are outside the betting area(s) for a predetermined duration of time. Conversely, the System may identify the start of the gaming round based on a determination that the playing cards are within the betting area(s) for a duration of time.

In one embodiment, the System may be configured to detect the presence or absence of playing cards on the betting areas and/or the game table. For example, when a card first appears on the table or near any of the betting areas, then the System identifies a start of a gaming round and logs a timestamp (e.g., marking as “Start of Round 5”). The System continues to monitor video frames from the cameras. When all the cards on the table or the betting areas are removed, then the System identifies an end of a gaming round and logs a timestamp (e.g., marking as “End of Round 5”). In one embodiment, a time buffer may be employed to confirm the end of the gaming round, e.g., when no cards are detected for a specific duration, then the end of the gaming round is confirmed).

In the above embodiments, one or more AI models may be implemented to identify a start and an end of a gaming round. The AI model(s) may be configured as a separate AI model, different from the AI models configured for identifying the betting areas or identifying the gaming articles. The AI model(s) configured for identifying a start and an end of a gaming round may receive input data from the System. In one embodiment, the input data may comprise the frames from the video feeds captured by the cameras. The 20 frames may be resized to Yolo dimensions (e.g., 640×640) in the Yolo model embodiment. For other AI models, the frames may be resized to fit into the dimensions suitable for those models. The AI model generates output data based its analysis of the input data. The output data may represent bounding boxes for cards or absence of cards, indicating the locations and confidence of detection.

In one embodiment, the start and end times of each gaming round may be recorded. The recorded data representing the start and end times of each gaming round may be stored on the database or as part of corresponding player's player profile or the like. In the above embodiments, the System provides a novel advantage by layering a time threshold to ensure that a “YES” or “NO” state is maintained for a continuous number of frames, wherein the “YES” state represents playing cards as being oriented upwards, and the “NO” state represents no playing cards as being detected on the gaming area. This prevents spurious or noisy detections from prematurely determining round start or end.

Identify Gaming Tokens/Chips/Currency: With respect to the fifth step of identifying one or more gaming tokens, the System may be configured to identify the one or more gaming tokens (e.g., casino chips/coins such as poker or blackjack chips, etc.), corresponding to the players, wherein the gaming tokens have a numerical value. One or more AI models may, based on the input data, identify the gaming tokens, such as one or more casino chips within the betting areas. The AI models for identifying the gaming tokens may comprise a Yolo model (e.g., Yolo segmentation model). Although the Yolo models are described as one of the embodiments of the present disclosure, it should be apparent that any other AI model suitable to detect or identify gaming tokens based on the images or video sequences of a game table may also be implemented in the System.

In one embodiment, the AI model(s) for identifying the gaming tokens may be separate AI models, different from the AI models configured to identify the betting areas, identify a start and an end of a gaming round, or identify the gaming articles (e.g., cards). For example, the AI model(s) for identifying the betting areas may be used as a first AI model, the AI model(s) for identifying the gaming articles may be used as a second AI model, the AI model(s) for identifying a start and an end of a gaming round may be used as a third AI model, and the AI model(s) for identifying the gaming tokens may be used as a fourth AI model. In another embodiment, one or more of these AI models may be combined/consolidated into one or two AI models.

FIG. 4 illustrates an example of a gaming area having gaming tokens, wherein an image of a game table image having casino chips is represented. The System may be configured to identify the casino chips 450 and 460 via the AI model. In this case, the AI model receives input data, which may comprise images of the game table having the casino chips 450 and 460, for example, cropped ROI representing each of the betting areas. In one embodiment, the cropped ROIs may be resized to Yolo input dimension (e.g., 640×640) in the Yolo model embodiment. For other embodiments where different models are used, the ROIs may be resized to fit into the dimensions suitable to those models. Based on this input data, the AI model may identify casino chip 450 as corresponding to Player 6. Similarly, the AI model may identify casino chip 460 as corresponding to Player 4. The System may be configured to generate output data, which may comprise segmentation masks and bounding boxes for each detected chip, as more fully described below.

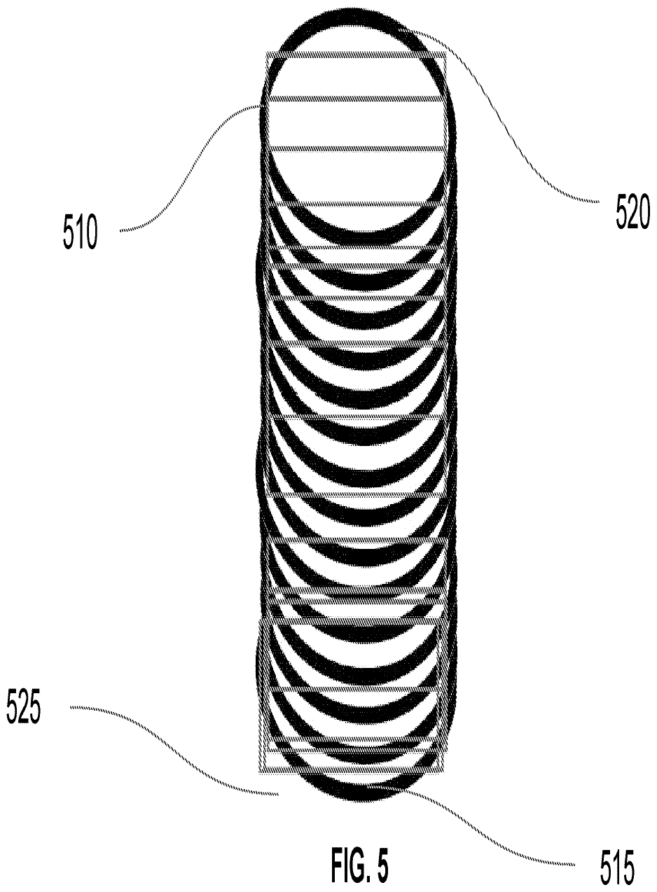

In one embodiment, the System may be configured to identify the gaming tokens by generating masks on the gaming tokens. Each mask may correspond to a gaming token of the one or more gaming tokens. The masks may represent at least one of the shape or position (or both) of each corresponding gaming token, such as the gaming chips 510 and 515 as represented in FIG. 5. For example, referring to FIG. 5, the mask 520 corresponds to the gaming chip 510, while the mask 525 corresponds to the gaming chip 515. The System may further identify a confidence score associated with the generation of the masks, wherein the confidence score represents a probability as to whether the generated masks are gaming tokens. For example, referring to FIG. 5, the System may identify a confidence score of 0.59 corresponding to gaming chip 510, wherein the confidence score represents that a likelihood of 59% that the gaming chip is accurately identified.

In one embodiment, the System may be configured to identify one or more stacks of the gaming tokens, such as one or more stacks of the casino chips. The System may identify stacks of the gaming tokens based on the identified individual gaming tokens.

In this case, the System may, after identifying the individual gaming tokens, determine one or more coordinates corresponding to each of the individual gaming tokens. The coordinates may represent a centroid of the individual gaming token, wherein the centroid represents the center. The System may then identify a distance matrix based on the distance between each pair of the one or more centroids. For example, if the System identifies centroid A, centroid B, and centroid C corresponding to gaming tokens A, B, and C, the System may then identify each of the distance between centroids A and B, A and C, and C and B, and generate a corresponding distance matrix comprising the identified distances. The distance matrix may comprise the identified distance between the centroids of all the gaming tokens.

In one embodiment, an AI model (e.g., a density-based clustering algorithm, etc.) may identify gaming tokens that are adjacent to each other based on the generated distance matrix. The AI model may receive input data corresponding to the distance matrix, and identify clusters of gaming tokens with the least distance between the respective centroids based on the generated matrix. Based on the identified pairs of gaming tokens, the AI model may generate output data, wherein the output data represents one or more stacks of gaming tokens. In this way, the System is able to identify stacks of gaming tokens, such as stacks of casino chips, that correspond to each of the players.

In one embodiment, the System may be configured to identify individual gaming tokens from the identified stacks corresponding to the one or players. The System may be configured to perform bitwise operations (e.g., AND, OR, XOR [exclusive OR], NOT, etc.) may be performed on the stacks to identify adjacent gaming tokens by determining a union/intersection of the adjacent gaming tokens. In this way, the individual gaming tokens in each stack may thus be identified, which may further optimize determination of betting data from the gaming tokens.

In one embodiment, the System may employ an additional algorithm or AI model (e.g., this model may be used as a fifth AI model) to identify a group/stack of gaming tokens (e.g., sets of adjacent gaming tokens) in the betting area. For example, a density-based clustering algorithm may be employed to determine a group/stack of gaming tokens in the betting area. In this example, based on the mask for each individual chip, the System may calculate the centroid coordinates of each chip (e.g., the center of the mask). The centroid coordinates may comprise two- or three-dimensional coordinates, or any other suitable dimensional coordinates. The System calculates a distance between the centroid of every combination of two chips and generates a distance matrix. In this way, a distance between the respective centroids of any pair of adjacent gaming tokens may be calculated. The distance matrix may comprise rows and columns, each representing all of the detected chips, and each element in the matrix represents a distance between two chips represented by corresponding row and column. By using the density-based clustering algorithm, the System is configured to group individual chips that are closest to each other into individual stacks. Input data for the density-based clustering algorithm may comprise bounding boxes of chips extracted from segmentation masks, the generated distance matrix and/or a distance threshold (eps) to determine and customize proximity. Output data for the density-based clustering algorithm may comprise a list of clusters where each cluster contains the bounding boxes for a stack of chips. In another embodiment, bitwise operations (e.g., AND, OR, XOR [exclusive OR], NOT, etc.) may be performed on the one or more stacks to determine at least one of an intersection or union of the one or more stacks with the identified betting boxes, via the fourth plurality of AI/ML models. In this way, stacks that are not determined to intersect with the betting box, are not considered as corresponding to the betting box and/or the player.

By treating each chip as a separate mask (entity), recognizing every stack of chips in the betting area, and/or applying bitwise operations, the System is capable of identifying any tokens (or stacks of tokens) that stand behind adjacent another stack of tokens, partially hidden behind another stack of tokens, or outside of the betting area (either partially or entirely). The process of deriving centroids of gaming tokens from masks and clustering them is crucial for determining the correct betting stack. This is especially important when the System is configured to employ side-view cameras, e.g., the cameras are positioned to take only one view of the overlapping stacks of tokens, thereby, not capable of taking images that provide a clear view all of the stacks of tokens.

In one embodiment, similar to the training data for the AI models configured to identify the betting areas, the training data for the AI model for identifying the gaming tokens may comprise augmented data. For example, the training data may comprise labeled images of the objects (e.g., chips) that need to be detected or segmented. The training data may be pre-recorded with cameras.

Color Classification In one or more embodiments, the System may further employ one or more additional AI model (e.g., this model may be used as a sixth AI model) to determine one or more betting values corresponding to the one or more gaming tokens. For example, the betting value may be determined based on one or more color features corresponding to the one or more gaming tokens via a K-Nearest Neighbor (k-NN) classifier or any other suitable models/algorithms for classifying colors based on visual images of an object.

In one embodiment, the sixth AI model(s) may be trained based on training data corresponding to the one or more gaming tokens. In this way, the sixth AI model is optimized to identify betting values corresponding to the gaming tokens, even if the gaming tokens are of a unique shape and/or experience varying conditions (e.g., lighting, etc.). The sixth AI model may be configured to detect or identify the color of each gaming token identified in the betting area. Input data for the sixth AI model may comprise features extracted from the chip regions (e.g., RGB values, histograms) derived using segmentation masks from the fourth AI model (e.g., the Yolo model) and output data for the sixth AI model may comprise color label for the token (e.g., “red,” “green,” “black”).

In one embodiment, the System may identify a monetary value based on the color features to determine one or more individual betting values corresponding to the one or more gaming tokens. In an illustrative example, the gaming token 460 placed by Player 4 in FIG. 4 is colored green and corresponds to a monetary value of $25.00. Accordingly, the gaming token 460 is identified to have a color feature of green by the sixth AI model and the corresponding value of $25.00 is determined for Player 4, as represented in FIG. 4.

In another illustrative example, the gaming token 450 placed by Player 6 in FIG. 4 is colored red and corresponds to a monetary value of $5.00. Accordingly, the gaming token 450 is identified to have a color feature of red by the sixth AI model and the corresponding value of $5.00 is determined for Player 6, as represented in FIG. 4 (where Player 6 has a stack of two green coins totaling $50.00 and two red coins totaling $10.00).

In another embodiment, the sixth AI model may be trained on local training data, wherein the local training data represents the specific betting values assigned to each gaming token of a color feature corresponding to the specific casino and/or gaming location having the game. In one embodiment, similar to the training data for the AI models configured to identify the betting areas, the training data for the AI model for identifying the color features of the tokens may comprise augmented data. For example, the training data may comprise labeled images of the objects (e.g., color features) that need to be detected or segmented. The training data may be pre-recorded with cameras.

Betting Value Determination With respect to the sixth step of identifying one or more betting values, the portion of the one or more gaming tokens having the same color feature of the color features may be identified to determine a total betting value corresponding to the players. For example, the quantity of the portion may be determined via the sixth AI model, and a corresponding feature betting sum may be determined based on the quantity of the number of gaming tokens having the same color feature and the corresponding individual betting value. The feature betting sum represents the sum of the individual betting values of the gaming tokens having the same color feature.

In another embodiment, the above-described process may be repeated for each color feature of the color features to determine feature betting sums for the gaming tokens having that respective feature. A total betting value may be determined based on the determined feature betting sums, for example, by determining a sum of the determine feature betting sums.

Error Identification and Mitigation In one embodiment, the System may identify errors (e.g., transient detection errors, etc.) in the identification of characteristics corresponding to at least one of the betting areas, gaming articles, gaming tokens, players, and/or other gaming objects by the AI model. To identify the errors, the System may compare the identifications by the AI model with a reference set of identifications. The reference set of identifications may comprise simulated sets of data, wherein the correct identifications are predetermined, and used to identify errors in the identifications made by the AI models. In an example, the System may provide the identified errors as confidence scores, and/or other numeric or textual quantities.

In another embodiment, the System may identify the errors via median and/or aggregation filtering techniques. For example, the System may identify betting values corresponding to a player during a gaming round based on video feeds captured by the one or more cameras. The System may then identify a frame betting value corresponding to each video frame of the video feeds, and determine a median betting value corresponding to the video feeds based on the frame betting values. The System may compare each of the frame betting values with the median betting value to identify errors and/or fraudulent behavior. In other examples, the System may identify an average corresponding to the frame betting values, and identify errors and/or fraudulent behavior based a comparison between each frame betting value and the average of the frame betting values.

### Storage of Identified Data

In one or more embodiments, data corresponding to the one or more captured representations, or data corresponding to any of the methods, systems, and the AI models and algorithms described above may be stored locally, for example, on a local server or database inside the premises having the game (e.g., casinos).

In one embodiment, one or more timestamps may be identified corresponding to actions undertaken by the one or more players, dealers, etc. For example, a timestamp corresponding to the start and/or end of at least one of the gaming session, gaming round, or player round may be stored on the database.

In one embodiment, one or more player numbers corresponding to each of the players may be identified via at least one AI model configured to identify the player number, based on identified unique identifiers corresponding to the gaming area.

In one embodiment, the database may be on-premises database system/server located within a casino or casinos. The database may be configured to be in electrical communication with a Casino Management System (CMS) system of the casino. The database may be configured to track and store for each bet played: (1) bet value; (2) timestamps (e.g., when bets are made, a start and end of each round, etc.); (3) player number on each table (e.g., Player 1 to Player 7); (4) round number; (5) Table ID (e.g., a unique ID for each table); and (6) Pit ID (e.g., a unique ID for each pit). Each player may have his or her Player Profile in the database. The Player Profile may comprise: a player's ID, account information, personal information, status (e.g., a VIP, membership status, etc.), game and betting history, wins/losses, average time played, player's rating, etc. In another embodiment, the database may further comprise a hand count (e.g., a number of hands player per round or game), average bet size (e.g., per round or game), a round count (e.g., a number of rounds played), etc. It should be apparent that any other information pertaining to the game or bet may also be stored on the database or the player profile.

In one embodiment, the Pit ID, Table ID, player number on the table, and timestamps may be used to joint bet values to the CMS system and existing player profiles in the database.

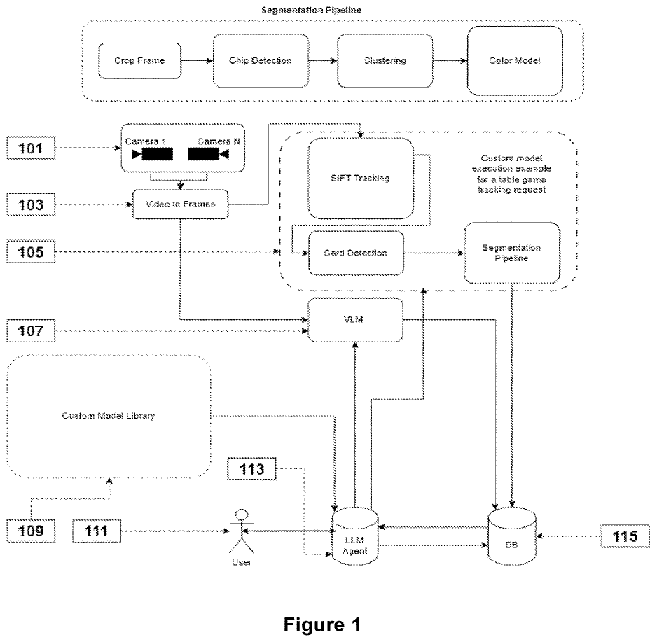

Fully On-Premise Solution In one or more embodiments, referring to FIG. 1, data identified, collected, processed, and/or analyzed by the System may be kept on-premise at all relevant times, e.g., stored and managed locally in a casino (or casino's system). For example, the identified and/or collected data via the sensing modalities 130 may be processed locally by the processor 100 and stored locally on the memory 110. All video processing and analytics may be performed within the casino's local network, for example, the network 120. In this way, processing and/or analyzing of the captured video frames may be conducted locally, for example, within a casino's local network, wide area network, or any internal communication network. This also ensures that no data is transmitted to external cloud services, maintaining data sovereignty.

In one embodiment, the System may be integrated with the casino's CMS system. In this embodiment, APIs or data interfaces may be developed between the System and the casino's CMS system to transfer processed data to the CMS system. Further, data formats and structure may be configured to be aligned to match CMS requirements.

Fraudulent Activity Detection In one or more embodiments, the System may be configured to detect anomaly conditions during a gameplay. In one embodiment, the System may be configured to employ one or more AI models (e.g., a seventh AI model) to detect anomaly conditions. For example, the AI models may comprise unsupervised algorithms that are configured to detect anomaly conditions. In one embodiment, the AI model may be configured to identify deviations in betting activity of each of the players, based on the player profile(s) corresponding to each of the players, such as the betting values identified for each corresponding player. For example, the System may, via the AI models, determine a betting average of a player based on the previous betting values corresponding to the player. The System may then compare the actual betting values corresponding to the player during a gaming round, with the betting average. Based on this comparison, if the actual betting value deviates from the betting average, for example, within a predefined range of deviation, the System may flag the gaming round for further analysis for fraudulent activity. The predefined range of deviation may be determined by a human operator or the System (and/or the AI model) based on certain factors, e.g., game type, age, gender, geographic, income, betting patterns/behaviors, etc.).

In another embodiment, the AI model may be configured to detect anomaly conditions based on usual or average bet values for the population. In this embodiment, the System (and/or the AI model) may be configured to determine a population size/group and a normal/average bet value for the population. The System may be configured to flag any player whose bet size deviates from the normal/average bet value for the population by a predefined range. The predefined range may be determined by a human operator or the System (and/or the AI model) based on certain factors, e.g., game type, age, gender, geographic, income, betting patterns/behaviors, etc.).

In one embodiment, the System may be configured to identify fraudulent activity, such as the unauthorized addition and/or removal of gaming tokens. For example, one or more AI models may be trained to identify that one or more gaming tokens have been added and/or removed from the gaming area during gameplay, for example, during a gaming round. In this embodiment, the AI models may comprise the Yolo model or the like the AI model may, upon a determination that the actual betting value corresponding to the player deviates from the betting average, identify fraudulently added and/or removed gaming tokens, such as poker chips, etc. The System may continuously monitor the gaming tokens to identify the fraudulent addition and/or removal of the gaming tokens.

In another embodiment, the System may be configured to identify fraudulent activity, such as card counting activity. For example, one or more AI models may be trained to identify that one or more players of the game is performing card counting techniques based on at least one of the gaming articles and/or the gaming tokens corresponding to the players. In one embodiment, the training data for the AI models may comprise data representing certain patterns of card counting such that the AI models are trained to detect such patterns in a real word setting. In this embodiment, the training data may be labeled and/or augmented to increase the accuracy of detection. In this way, the System may be configured to identify sudden changes in betting values with respect to the playing cards dealt during the gaming round. For example, the AI model may identify that a player of the one or more players placed a high betting value after several placements of low betting values. The AI model may further identify that the high betting value was placed by the player during a gaming round under favorable conditions, i.e., a high and/or low count/number of playing cards.

In another embodiment, the System may be configured to identify fraudulent activity, such as whether one or more of the players are engaging in collective fraudulent action with other players or dealers (e.g., collusion). For example, one or more AI models may be trained to identify that one or more of the players or dealers are engaged in collective fraudulent action based on input data captured by the sensing modalities (e.g., cameras, etc.). The AI models may comprise the Yolo models or the like.

In one embodiment, the System may be configured to generate one or more reports corresponding to the fraudulent activity that may be identified by the System. For example, the System may generate a report corresponding to the identified fraudulent activity, wherein the report may include data corresponding to the fraudulent behavior captured by the sensing modalities such as the cameras or detected by one of the AI models.

Detection of Fraudulent Activity Based On Temporal Analysis and Pattern Recognition In one embodiment, the System may identify fraudulent activity based on the detected movement of gaming tokens on the gaming area, including movement of the gaming chips between the players and dealer. The identification may be performed by the same AI model configured to identify the betting areas, and/or may be a separate AI model from the AI model configured to identify the betting areas. For example, the System may detect the movement of gaming chips outside of the appropriate time for placing a bet, and flag the action for player corresponding to the gaming chips for fraudulent activity based on this detection. In another example, the System may identify the frequency of the movement of gaming chips between the dealer and the specific player (e.g., excessive winning chips given to one player without a legitimate game reason, etc.) To determine whether one or more players are colluding in the fraudulent activity, the System identifies whether the one or more players are placing bets sequentially. The System may further identify the fraudulent activity upon a detection that the one or more players employ similar betting strategies (e.g., betting on the same hand during multiple rounds, increasing and/or decreasing bets, etc.).

Detection of Fraudulent Activity Based on Movement In one embodiment, the System may be configured to detect hand movements between players to identify fraudulent behavior corresponding to the players. For example, one or more AI models may be configured to detect hand movements of one or more players that indicate the fraudulent passing of at least one of the gaming articles and/or gaming tokens to each other, and flag the corresponding player for fraudulent activity. The AI models may comprise a Yolo model or any other AI model suitable to detect such hand movements between players.

In another embodiment, the System may identify fraudulent activity upon a based on the positions of the identified gaming tokens. For example, the System may identify that the gaming tokens corresponding to a player have entered or exited the betting area corresponding to the player, and flag the player for fraudulent activity.

Detection of Fraudulent Activity Based on Betting Amounts In one embodiment, the System may be configured to employ statistical correlation techniques to determine whether players are colluding in fraudulent activity. For example, the System may detect that betting values corresponding to different player have the same characteristics, such as the timing of the betting values. Based on this detection, the System may identify that the players are colluding in fraudulent activity, such as players that are betting similar values and/or players that are placing bets at similar times.

In another embodiment, the System may be configured to determine betting patterns corresponding to the players. The System may further detect variations in the betting patterns to detect fraudulent activity. For example, the AI model, which may be the same as and/or separate from the AI model configured to identify the one or more betting areas, may determine that a first player having a first betting pattern places a bet that matches a second betting pattern of a second player. Based on this determination, the AI model may identify collusion between the first player and the second player.

In another embodiment, the System may be configured to communicate the generated reports to a memory and/or a database via a network (e.g., the network 120 in FIG. 1), the memory and/or databased being stored locally and/or separately. For example, the System may be configured to generate a notification in response to the identification of fraudulent activity. The System may further communicate the notification via the network to a memory, such as a memory located on a computing device used by casino staff. In this way, the relevant authorities, including casino staff and law enforcement entities may be alerted to fraudulent activity identified by the System, as soon as such activity is identified. The System may further securely store the generated reports (and/or relevant video clips and data) in the memory and/or database, for example, via any suitable encryption techniques.

In another embodiment, the System may be configured to compare the identified fraudulent activity with data captured by separate sensing modalities. Upon an identification of fraudulent activity corresponding to a player, the System may, via one or more AI models identify the players, for example via facial recognition techniques, such as Yolo models or the like. The System may then access sensing modalities located in the casino having the gaming area to monitor gaming activity corresponding to the player. For example, the AI model may receive input data, wherein the input data comprises video feed captured by the cameras. Based on the input data, the AI model may identify one or more face embeddings corresponding to facial features (e.g., eye centers, nose tip, and mouth corners, etc.) of the players' faces captured on the video feed, for example, via Deep Convolutional Networks (CNNs). The AI model may compare the identified face embeddings with a set of reference face embeddings (e.g., via Cosine Similarity and/or Euclidean Distance techniques, etc.) to determine whether an identity of the player, wherein the set of reference face embeddings represents players whose identities are known.

Presentation of Identified gaming Activity In one or more embodiments, the System may be configured to display visual data corresponding to the above identified gaming activities of the players, including the identified gaming betting areas, the identified gaming articles, the identified gaming tokens and the corresponding betting values, and/or the identified gaming rounds. The System may present the visual data, for example, via one or more displays. For example, referring to FIG. 1, the System may cause the displays 150 to display the visual data corresponding to the gaming activities of each of the players. The output data may represent at least one of the player numbers, the average betting value, the handle, the hands played and/or the gaming rounds played, and any applicable metric determined from the identified gaming activity.

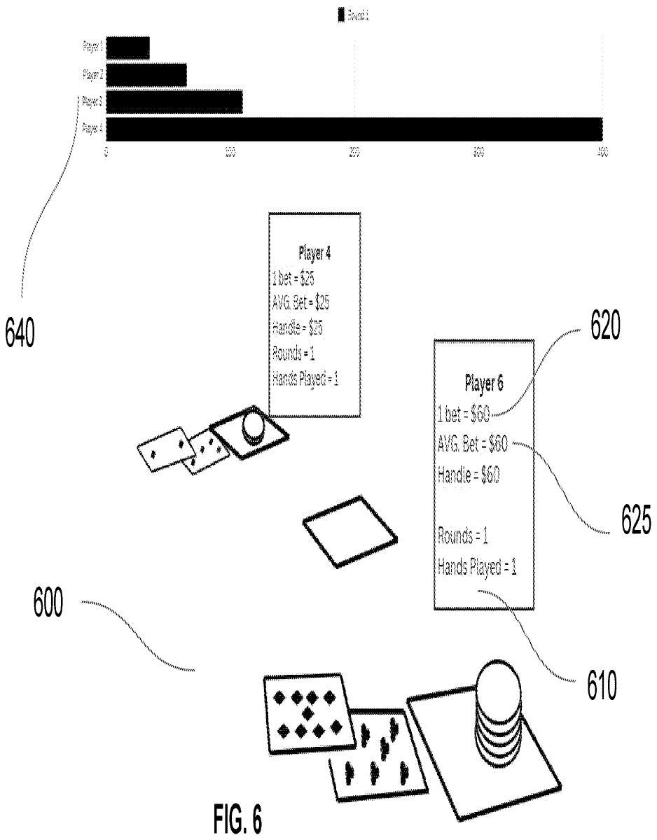

In an illustrative example, and referring to FIG. 6, a display (e.g., the displays 150 in FIG. 1) may render visual data comprising an activity box 610 overlaying a main screen 600, wherein the main screen 600 is a continuous rendering of video feeds captured by the cameras, etc.). The activity box 610 may visually represent one or more metrics, for example, in a text-based manner such as metrics 620 and 625, wherein metric 620 corresponds to a betting value placed during a gaming round and metric 625 corresponds to the betting average for Player 6. The display may further render visual data comprising a graphical rendition (e.g., bar graphs, plots, etc.) corresponding to the gaming activity of the players. In FIG. 6, the graphical rendition 640 represents the betting values corresponding to each of Player 3, Player 4, and Player 6.

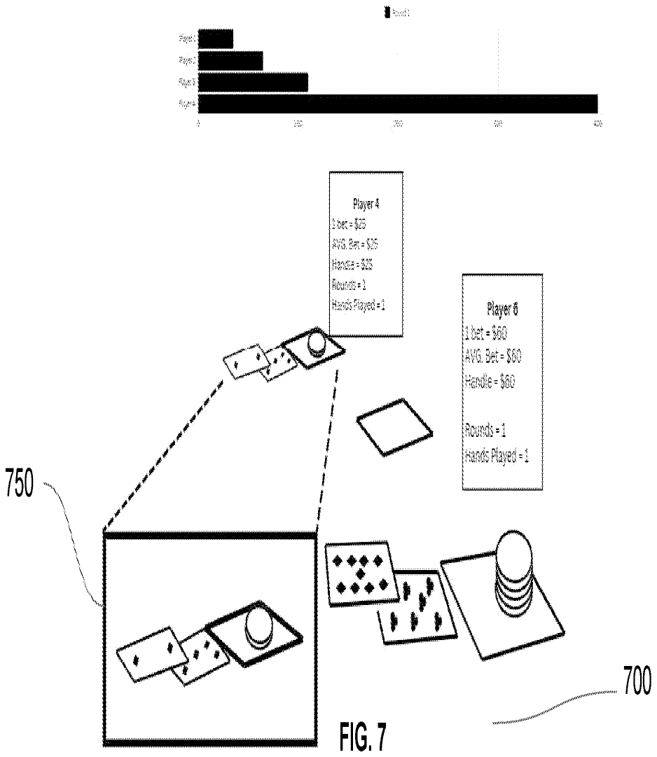

In another embodiment, and referring to FIG. 7, the display may further render a focused view 750 overlaying the main screen 700. The focused view 750 may correspond to the betting areas identified by the System, wherein the focused view 750 is a continuous rendering of the video feeds corresponding to the betting areas. In FIG. 7, the focused view 750 is a zoomed-in representation of the betting area corresponding to Player 6. The display may display multiple such focused views, each of which may correspond to the respective betting areas of the players playing the game.

The systems and methods illustrated and discussed herein may be applied to any and all suitable card games, including the game of blackjack, with the principles and features of the invention being adaptable to any suitable card games that employ the use of at least one of gaming articles (e.g., playing cards, etc.) and/or gaming tokens (e.g., poker chips, etc.), or a suitable equivalent of either.

The systems and methods illustrated and discussed herein may have various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules, units, or other components can be combined or segregated as hardware and/or software stored on a non-transitory computer-readable medium as modules in any manner, and can be used separately or in combination.

Although the devices, systems, apparatus and methods have been described and illustrated in connection with certain embodiments, variations and modifications will be evident to those skilled in the art. Such variations and modifications may be made without departing from the spirit and scope of the present disclosure, and are therefore anticipated. The description and teachings herein are thus not to be limited to the precise details of methodology or construction set forth herein because variations and modifications are intended to fall within the spirit and scope of the present disclosure. In one embodiment, the System may be configured to generate behavioral metrics for each player (or a group of players). The behavioral metrics are designed to show a player's playing style and betting patterns. For example, the behavioral metrics for a player may comprise any of the data sets described above in connection with the player ratings, including but not limited to, an average bet size, an average amount of bets during a game session/round, a bet variance (e.g., the variability in the player's bet sizes over a game round/session, or across multiple rounds/sessions/games), a bet frequency (e.g., the number of bets placed per hour or per round), win/loss ratios (e.g., the ratio of the total amount won versus the total amount lost), a betting time (e.g., the average time taken to place a bet after a round starts), a preferred bet range (e.g., the most common bet range, for example, $10-$20 or $50-$100, for the player), a session duration (e.g., the average length of a gaming session for the player), betting Hot/Cold Streaks (e.g., the identification of consecutive wins or losses), behavioral anomalies (e.g., sudden spikes or dips in bet sizes or frequencies compared to the player's behavioral data), and a multi-table play (e.g., tracking if the player frequently moves between tables and their performances across different tables). In one embodiment, the System may be configured to employ an AI model or algorithm to analyze the behavioral metrics. For example, any suitable machine learning algorithms or statistical methods may be employed to analyze the behavioral metrics. In one embodiment, any suitable anomaly detection algorithm or method, such as a K-means algorithm, a support vector machine, a Z-Score method, etc., may be employed to detect any unusual betting pattern or playing style. For example, if the player is engaging in aggressive betting, then that aggressive betting pattern may be detected by the System and recorded in the corresponding Player Profile in the Database.

In contrast, if the player is engaging in unusually conservative betting, then that conservative betting pattern may be detected by the System and recorded in the corresponding Player Profile in the Database. In one embodiment, the System may be configured to further notify such a pattern (whether aggressive or conservative) to an appropriate team/department at a casino for taking any further necessary action.

In one embodiment, the System may be configured to monitor tendencies like doubling down, splitting in blackjack, etc., across multiple game sessions/rounds. The System may be configured to employ the same machine learning algorithms or statistical methods that may be used for analyzing betting patterns. Once these tendencies are detected, the System may also be configured to notify such tendencies to the appropriate team/department at the casino for taking any further necessary action or analysis. In one embodiment, the System may be configured to create a report of the betting patterns, playing styles, player ratings, and/or tendencies of a player (or a group of players). The report may be created in the form of a visual dashboard that may be displayed on an electronic device. The electronic device may comprise any device with a screen such as a mobile phone, tablet, computer, etc. The dashboard or the report may be provided to the management of a casino for further analysis and for utilizing such information to create marketing materials tailored to specific types of customers. Casino management may be provided with access to the visual dashboard as well. In another embodiment, any notable deviation in players' behaviors, betting patterns, playing styles, and/or tendencies may be notified to an appropriate staff at a casino.

In one embodiment, the System may be configured to record data across multiple sessions to identify trends in player's betting patterns or playing styles. In one embodiment, statistical methods may be employed to quantify playing styles and changes over time. For example, unsupervised learning techniques may be employed to quantify player behaviors over time. In one embodiment, two approaches may be used: (1) historical self-comparison; and (2) player persona clustering at population level.

With respect to the historical self-comparison approach, the System may be configured to compare an individual player's playing style with their historical data to identify unusual behavior or significant deviations. For example, if a player begins making larger bets compared to their historical average, this may be flagged as a deviation from their typical playing pattern. With respect to the player persona clustering approach, the System may be configured to employ one or more clustering algorithms to group players based on their playing styles at each casino. The idea is to derive different player personas, which may help casinos understand their player base and create tailored marketing strategies. The personas may be based on metrics such as bet size, frequency, duration of play, and more. The AI derived metrics may then be combined with pre-existing player information that the casino might already have such as demographics, etc. For example, three player personas may be used: (1) High Roller (e.g., players who consistently place large bets, often taking higher risks); (2) Casual Player (e.g., players who typically make small, conservative bets and spend longer periods at the table); and (3) Opportunistic Player (e.g., players who place medium-sized bets but increase their stakes sporadically based on perceived opportunities). In one embodiment, the clustering may be refreshed periodically (e.g., monthly, weekly, etc.) to reflect changes in playing styles due to organic behavior or casino marketing strategies. Players may move between different personas over time.

In one embodiment, the System may be configured to display each player's game status in real time on a display. FIG. 2 illustrates an example of a screen for monitoring how each player is playing the game in real time. In FIG. 2, a game table 200 is shown with a plurality of betting areas 210 (e.g., main betting areas). For each player, an activity box 220 is displayed to show the game status of the player. For each round, each player's average bet (“AVE. Bet”), handles (“Handle”), rounds (“Rounds”), and hands played (“Hands Played”) may be displayed in the activity box 220 on the screen in real time. Each activity box may be configured to correspond to each betting area (or the playing cards placed in connection with the betting area) and/or player. For example, for Player 1, a box titled Player 1 may be displayed. For the Player 2, a box titled Player 2 may be displayed. Each box is appropriately labeled to identify the player who is currently using the betting area that corresponds to the box. Each activity box may also be configured to display the betting value of each round of betting. For example, the activity box 320 displays the first betting value ($60), the second betting value ($75), and the third betting value ($150) of Player 6. In one embodiment, each player's betting value may be indicated a bar graph 240, as shown in FIG. 2.

Still referring to FIG. 2, the average bet may indicate an average bet size (e.g., per round or game) of the corresponding player. The handles may indicate a total bet size (e.g., wagered from the start to the end of the game) of the corresponding player. For example, if Player 3 played three rounds of the game, and has wagered $40 (first round), $200 (second round), and $30 (third round) each, then Player 3's average bet may indicate $90 and handles may indicate $270. The rounds may indicate a number of rounds (e.g., per game) played by the corresponding player in a game. The hands played may indicate a number of hands (e.g., per round or game) played by the corresponding player in a game. These boxes are provided only as examples, and it should be apparent that the boxes shown in FIG. 2 may take any other suitable form, shape, size, etc. to display players' game status. It should be also apparent that the content of the boxes of FIG. 2 may be different and other information about the players or the games may be displayed as well. Further, the same game status shown in FIG. 2 may be displayed per game table or a specific group of players. For example, the same game status may be displayed based on each table (e.g., average bet size per table), not based on each player.

In one embodiment, the above game status (and/or other information that may also be displayed) may be used for analyzing players' performance/ratings.

In one embodiment, the above game status (and/or other information that may also be displayed) may be stored on the corresponding Player Profile and/or the Database. In another embodiment, the same information may be transmitted to the CMS system to be managed by a casino.

There may be one or more methods of monitoring and analyzing player activities and performances according to one or more embodiments of the present disclosure. The present disclosure is not limited to the sequence or number of the operations of the method illustrated by these flowcharts, and can be altered to any desired sequence or number of operations as would be evident to one skilled in the art. For example, in some embodiments, the order may vary, some of the processes may be performed concurrently or sequentially, the method may include fewer or additional operations, or the like.

Dealer Analytics In one embodiment, the System may be configured to analyze and evaluate dealers' performances (e.g., provide dealer analytics). The System may be configured to monitor dealers' activities, for example, hand dealing rates, win/loss distribution, etc. The System may be configured to provide dealer analytics for any type of card games, such as blackjack, poker, baccarat, etc.

With respect to the hand dealing rates, the System may be configured to calculate the hand dealing rate, e.g., a number of rounds/hands handled by a dealer per hour (or within any other timeframe). In one embodiment, the hand dealing rate may be calculated by timestamping the start and end of each round. For example, the start and end of each round may be timestamped. Based on the start and end of each round, the number of rounds handled by the dealer in one hour (or any other timeframe) may be calculated. In another embodiment, the start and end of each hand may be timestamped. Based on the start and end of each hand, the number of hands handled by the dealer in one hour (or any other timeframe) may be calculated. Timestamping each round/hand may be conducted in the same manner as described above in connection with calculating the player ratings.

With respect to the win/loss distribution, the System may be configured to employ one or more AI models to detect the sequence of events, in the same manner as described above with respect to the calculation of the win/loss ratios of players. For example, if a dealer adds additional chips to a player's betting area, then it indicates a loss to the dealer. If the gaming tokens are removed from the betting area by the dealer, then such a movement indicates a win for the dealer. The value of the removed chips or added chips may be calculated in the same manner as described above with respect to the calculation of the win/loss ratios of players. The dealer's overall win/loss performance may be determined by aggregating the outcomes of each player across multiple rounds. The overall win/loss performance indicates how well the dealer performed against the entire table during a session. The win/loss performance or distribution for a dealer may be stored on the Database. In one embodiment, the win/loss performance or distribution of a dealer may be stored in that dealer's Dealer Profile. Each dealer may have his or her Dealer Profile. The Dealer Profile may comprise any information or data relating to the corresponding dealer. The Dealer Profile may be configured as part of the Database or the CMS system. In one embodiment, instead of calculating the win/loss distribution, a number of wins, a number of losses, and/or a win/loss percentage/ratio may be calculated and stored in a dealer's Dealer Profile.

In one embodiment, the System may be configured to detect dealer errors. The System may be configured to monitor for deviations from standard dealing procedures. In one embodiment, the System may be configured to employ deep learning and pose estimation models to detect dealer errors or deviations from standard procedures. Alternatively, the System may be configured to use bet value data, either alone or in combination with the deep learning and pose estimation models to detect dealer errors or deviations from standard procedures. The bet value data may comprise a bet size, an average bet size, and/or a total bet amount per game/table, etc. The bet value data may be tracked by one or more AI models (e.g., Yolo models or the like). For example, the AI models may analyze images or video sequences of a game table, including gaming tokens placed on the betting areas to calculate the bet value.

In one embodiment, as described, the System may be configured to detect a player's win or loss (or a dealer's win or loss). In this embodiment, the System may further be configured to compare the detected win/loss to the movement of the gaming tokens or the bet values. For example, if the player lost, then no tokens should be passed to the player. In such an instance, if the System detects any passing of tokens to the player, then the System is able to determine that an error has occurred. One or more AI model (e.g., a Yolo model or the like) may be employed to detect the movement of tokens on the game table. In another example, if the player won, the System may be configured to verify that the correct amount/value of tokens (based on a payout ratio) is provided to the player. The System may be configured to detect the payout ratio based on the detected win/loss and the information indicated in the betting area (e.g., “2:1”). Alternatively, one or more pre-defined payout ratios (e.g., in blackjack, a typical payout may be pre-defined as “1:1” or “2:1”) may be used as a reference payout ratio in a specific type of game. If the player placed a $100 bet on a blackjack table and won at a 3:2 payout ratio, then the expected payout is $150. If the detected payout is $140 or $160, then the System may flag as a dealer error.

In one embodiment, one or more cameras may be implemented to capture an image or video sequence of the dealer activities. This image or video sequence may be taken from a top view camera (e.g., from the camera positioned to take a top view of the dealer hand movement, etc.). For pose estimation, additional AI model(s) may be employed. In one embodiment, these additional AI models may comprise a Yolo model trained for pose estimation/detection, or any other suitable AI model for pose estimation/detection. The AI models may be configured to detect misdeals or procedural errors made by a dealer based on the pose estimation or captured images/videos of the dealer activities. In one embodiment, the AI model(s) (e.g., pose estimation models such as a Yolo model and OpenPose) may be configured to recognize the dealer movements, and map the recognized movements with pre-defined standard movements. For example, each game (e.g., blackjack, poker, etc.) has pre-defined dealer movements and procedures such as shuffling and dealing cards, collecting bets or tokens, distributing payouts, etc. These movements may be encoded as reference poses or sequences. The recognized dealer movements may be compared with the reference poses or sequences.

If any deviation from the reference poses or sequences is recognized, then the System may be configured to flag that deviation. In one embodiment, a pre-defined threshold may be applied, and any deviation greater than the threshold may be determined to be an error. In this embodiment, the threshold may be set by a casino.

In one embodiment, the System may be configured to identify dealer errors based on three instances: (1) misalignment or deviation from standard movements: (2) sequence timing and order; and (3) detection of non-standard behavior.

With respect to the first instance, the System may be configured to identify if a dealer's movement deviates significantly from the references. For example, if playing cards are dealt to a wrong position, skipped, or exposed unintentionally, then the System identifies such a movement as a misdeal. If gaming tokens are placed in a wrong betting area or given to a wrong player, then the System identifies such a movement as an incorrect payout. If dealer failed to collect losing bets or collect tokens properly, then the System identifies such a movement as a bet handling error.

With respect to the second instance, the System may be configured to track the sequence and timing of actions. For example, if a dealer skips steps or performs actions out of order, then the System may flag it as a potential error.

With respect to the third instance, the System may be configured to detect unexpected or prohibited behaviors. For example, if dealer's hands are straying into unauthorized areas (e.g., near personal belongings), then it may indicate a breach of protocol. This type of misconduct may be detected by observing the dealer's hands. If unusual pauses or hesitation in dealing is detected, then it may indicate confusion or error by the dealer. In one embodiment, one or more AI models (e.g., a Yolo model or the like) may be employed to detect the dealer's hands. In one embodiment, the System may be configured to further notify such an error to an appropriate team/department at a casino for taking any further necessary action.

In one embodiment, the System may be configured to generate a report on dealer performance metrics. The dealer performance metrics may comprise the hand dealing rates, the win/loss distribution, or any other information relating to dealers' performances and/or errors. The report may identify areas for improvement and recommend training modules for a dealer. The report may be created in the form of a visual dashboard that may be displayed on the electronic device. In one embodiment, the report for dealers' performances may be included in the same display/dashboard as the report for players' ratings. Similar to the report for players' ratings, the report or the dashboard may be provided to the management of a casino for further analysis and for utilizing such information to create marketing materials tailored to specific types of customers.

In one embodiment, the System may be configured to generate an alert when any threat or anomaly condition is detected by one or more of the algorithms/models described above. In one embodiment, the alert may be in form of an electronic message (e.g., a text message, a video message, an audio message, a report, etc.) that may be automatically generated by the System in real time. The alert may be sent to security personnel (or any other suitable personnel/team) at the gaming venue through a local area network, a wide area network, or the Internet. In another embodiment, the alert may be sent to the security personnel (or any other suitable personnel/team) through a dedicated application or the Casino Management System (CMS) of the gaming venue.

In another embodiment, the alert may be in form of a visual and/or audio alarm.

In this embodiment, the video alert may be displayed to the security personnel (or any other suitable personnel/team) on a screen of an electronic device (e.g., mobile phone, tablet, computer, etc.), and the audio alert may be announced by playing an audio clip through one or more speakers. The speakers may be installed in any location of the gaming venue or may be built-in speakers of the electronic device. In another embodiment, the alert may be in form of a report. The report may be created and displayed through the electronic device. The report may be transmitted to the security personnel at the gaming venue or the CMS system.

In one embodiment, the System may be configured to provide a video lookback/search function. The System may be configured to employ one or more large language models configured to vectorize video data. For example, the images or video sequences captured by the sensing modalities may be converted into the vectorized video data. The vectorized video data may be stored in a database or the CMS system. The vectorized video data may be structed in a way to allow a search. The search may comprise an open-ended text-based search. For example, if the open-ended text-based search matches the vectors of any video data, then the corresponding video snippets may be retrieved from the database and displayed to an operator of the System.

In one embodiment, the System may be configured to interact with the database and/or the CMS system of the gaming venue. The database may be configured to be in electrical communication with the CMS system and/or the System. The database may be configured as part of the System. The database may be configured to track and store one or more of the data sets that are described above in connection with the algorithms/models and the System. For example, the database may be configured to store the images or video sequences captured by the sensing modalities; any data that is analyzed by the algorithms/models; any training data used for training the algorithms/models; any output data generated by the algorithms/models; any threshold (or any other factors/criteria) that may be set by the System or the System operator in connection with use of the algorithms/models; and the alerts, reports, or logs of the alerts.

It should be apparent that any other data/information that may be used or generated by the System (and/or the algorithms/models described above) may also be stored on the database.

The System is configured to enhance security of the gaming venues through advanced surveillance features. By leveraging AI and video feeds, the System proactively identifies potential threats or anomaly conditions such as physical altercations or the presence of weapons in the gaming venues. The System further provides timely alerts to security personnel at the gaming venues such that the gaming venues may take any necessary actions to proactively remove the threats or conditions.

The methods and algorithms illustrated and discussed herein may have various modules which perform particular functions and interact with one another. It should be understood that these modules are merely segregated based on their function for the sake of description and represent computer hardware and/or executable software code which is stored on a computer-readable medium for execution on appropriate computing hardware.

The various functions of the different modules, units, or other components can be combined or segregated as hardware and/or software stored on a non-transitory computer-readable medium as modules in any manner, and can be used separately or in combination.

Although the devices, systems, apparatus and methods have been described and illustrated in connection with certain embodiments, variations and modifications will be evident to those skilled in the art. Such variations and modifications may be made without departing from the spirit and scope of the present disclosure, and are therefore anticipated. The description and teachings herein are thus not to be limited to the precise details of methodology or construction set forth herein because variations and modifications are intended to fall within the spirit and scope of the present disclosure.

In parent U.S. Ser. No. 19/067,927, filed 2 Mar. 2025 and titled Oversight Security System for Work Environments (which is incorporated by reference herein in its entirety), the application defines a system using Large Language Models (LLMs) to interpret verbal or textual input from authorized casino personnel and convert it into structured digital commands. These commands directed subsystems—such as video retrieval, facial recognition, or anomaly detection—to retrieve and analyze specific views, audio, or behavioral patterns based on operator intent.

This application describes the integration of a new analytic module into that broader LLM-controlled surveillance framework: a chip stack monitoring and past posting detection tool acting in cooperation with existing or additional sensing devices (motion sensors, cameras, optical recording systems, image comparison systems, and the like). The LLM agent, previously used to coordinate multiple tools, can now call upon this module dynamically as part of its reasoning and analysis capabilities.

### 1. System Components Overview

The past posting detection pipeline has at least the following tightly coupled components:
ROI Manager: Loads predefined table-specific bounding boxes for player betting areas and playing zones—this is the Region of Interest (ROI). It manages spatial cropping (both visual, weight determination, etc.) for downstream modules.
Game State Detector: Classifies whether the game is “active” by running a YOLO (you only live once) model to detect cards in play (e.g., face-up cards on table).
Hand Detector: Uses image features (e.g., RTM pose or similar models) to determine the presence and the type of hands (dealer vs. player) within each betting area.
Betting Area FSM (Finite State Machine): Tracks per-seat temporal state conditions and transitions such as:
   IDLE: No hand present.
   PLAYER_HAND: Player reaches into betting area.
   DEALER_HAND: Dealer reaches into betting area.
   COOLDOWN: Post-hand state with temporary analysis freeze.
   These states control whether chip analysis is valid and whether chip changes are considered actionable or ignorable.
Chip Monitor: Performs chip stack change analysis via:
   YOLOv8 [a computer vision model architecture that you can use for object detection, segmentation, key-point detection, and more] object detection (model trained for chip stack localization). This may be visually determined, or local weighing at each wager position may be performed.
   Structural Similarity Index (SSIM) to compare current vs. reference cropped betting area images or weights.
   Stack counting logic.
   Rules for classifying the type of change. For example changes in numbers of chips (visual count or by weight) or colors of chips (indicating value changes).

### 2. Detection Process: Frame-by-Frame Analysis

The ML Inference Pipeline process frame ( ) function orchestrates this logic on every incoming visual or weight determined frame:

### 1. Frame Preprocessing:

The frame is optionally cropped to a predefined “playing area” ROI.
Betting areas are adjusted to match this sub-frame, or the frames are calibrated to match betting areas.

### 2. Game State Evaluation:

Game State Detector is game active ( ) checks for presence of face-up cards or face-down or combinations thereof.
If no cards are detected, the frame is skipped or marked “inactive.”

### 3. Per-Seat Analysis:

This is performed for each seat ID. Each individual seat is given at least a table unique (if not casino unique) identification number/code.
   a. Betting Area Extraction:
ROI Manager provides coordinates.
Crop is extracted for SSIM (structural similarity index manager) and YOLO analysis.
   b. Hand Detection:
Hand Detector infers whether a player or dealer hand is currently present. This is typically an imaging component or motion detector, but could also be a weight detection component.
This signal updates the per-seat FSM, which determines whether chip monitoring should be suppressed (e.g., during hand presence or cooldown).
   c. Chip Analysis:
Chip Monitor to analyze one or more regions ( ) is invoked with:
   Cropped betting area
   Hand context (dealer present or not)
Internally:
   YOLO runs inference→bounding boxes for chip stacks.
   Stack count from YOLO is recorded.
   SSIM is computed between current and reference frame.
   Reference is updated after every frame to maintain time continuity.
      d. Change Classification Logic:

Chip changes are classified with execution of software into five types using the following logic:

| Condition | Classification |
|---|---|
| Stack count = 0 | EMPTY |
| Stack count changes (with/without dealer) | NEW_STACK |
| Stack count same, SSIM > threshold (e.g., 0.90) | NO_CHANGE |
| Stack count same, SSIM < threshold, dealer present | MINOR_CHANGE |
| Stack count same, SSIM < threshold, dealer not present | UNAUTHORIZED (→ alert) |

e. Reference Frame Handling:
After every chip analysis, the current crop becomes the new reference.
Stack count is also persisted for comparison in future frames.

### 3. Temporal Gating via FSM

The Betting Area FSM (final state analysis) prevents false positives by enforcing temporal gates:
Chip changes are only actionable when:
   FSM is not in a hand-active state (PLAYER_HAND, DEALER_HAND)
   FSM is not in cooldown
   Game is considered “active”
This ensures that only unauthorized player-originated changes are flagged, and legitimate chip movements (e.g., dealer payouts or pre-bet handling) are suppressed.

### 4. Past Posting Detection Criteria

A suspected past posting event is raised when all of the following are true:
game_state==“active”
fsm.should_monitor_chips==True.
chip_change_type∈{MINOR_CHANGE, UNAUTHORIZED}
last_hand_context!=“dealer” (i.e., change not linked to dealer interaction)

These checks are done in an ML Inference Pipeline process_frame( ) and results are shown in the event field: json CopyEdit {“event_type”: “past_posting_suspected”}

Additional metadata includes:
SSIM similarity score
Stack count and delta
Region mean/std
Timestamp and seat ID
Hand presence state
   5. Integration with LLM Agent

The output of the chip monitor pipeline is a structured event per seat per frame. This is made available to the LLM agent via:
Direct function call (Python API or service endpoint)
JSON-based response to prompts
Indexed in a vector store or relational DB for temporal queries

LLM usage patterns include:
“Did anything unusual happen at Table 3, Seat 6 after 9:45 PM?”
“Show me all UNAUTHORIZED chip changes for round 12.”
“Why was a past posting alert raised at 10:17:35 PM?”

The LLM combines chip events with gesture, card state, voice logs, or dealer context to build semantic narratives or forensic timelines.

Abbreviations and Definitions

| Abbreviation | Full Term | Definition |
|---|---|---|
| LLM | Large Language | A type of artificial intelligence model trained on vast |
| | Model | amounts of text to understand and generate human- |
| | | like language. Used here to interpret natural language |
| | | commands from casino staff and orchestrate |
| | | surveillance actions. |
| ROI | Region of Interest | A predefined rectangular area within a video frame |
| | | that represents the spatial boundary of interest, such |
| | | as a player's betting zone. |
| ROIManager | Region of Interest | A system component responsible for loading and |
| | Manager | managing ROI definitions (e.g., betting areas) and |
| | | providing spatial cropping for other modules. |
| FSM | Finite State | A logic control model used to manage the temporal |
| | Machine | state of a system-in this case, to track hand presence |
| | | and cooldown phases per seat. |
| BettingAreaFSM | Betting Area | A per-seat implementation of an FSM that transitions |
| | Finite State | between states like IDLE, PLAYER_HAND, |
| | Machine | DEALER_HAND, and COOLDOWN to manage |
| | | chip monitoring logic. |
| SSIM | Structural | An image similarity metric used to compare the |
| | Similarity Index | current video frame region to a reference frame to |
| | Measure | detect visual changes in chip stacks. |
| YOLO | You Only Look | A real-time object detection model used here to detect |
| | Once | and count chip stacks in betting areas. YOLOv8 is the |
| | | specific version used. |
| ML | Machine Learning | A branch of artificial intelligence where models learn |
| | | patterns from data. Used in this system for chip, card, |
| | | and hand detection tasks. |
| API | Application | A software interface that allows components (e.g., the |
| | Programming | LLM agent) to call functions such as the chip |
| | Interface | monitoring pipeline. |
| RTMpose | Real-Time Multi- | A vision model used to detect body and hand poses to |
| | person Pose | differentiate between player and dealer hands. |
| | Estimation | |
| ChipMonitor | — | A module that analyzes chip stack changes using a |
| | | combination of YOLO-based object detection and |
| | | SSIM frame comparison. |
| GameStateDetector | — | A module that determines if a game is active by |
| | | detecting visible cards using a trained vision model. |
| HandDetector | — | A module that classifies whether a hand in a betting |
| | | area belongs to the dealer or the player, based on |
| | | visual analysis. |
| MLInferencePipeline | Machine Learning | The central orchestration logic that executes per- |
| | Inference Pipeline | frame analysis across all seats, manages FSM |
| | | transitions, and routes outputs to the LLM agent. |

1. A system for overseeing security at a gaming facility comprising:
a) at least two live video streaming cameras having non-identical fields of view;
b) a feed from the at least two live video streaming cameras to a central processor;
c) at least two audio transmission-reception devices providing audio feed into the central processor;
d) at least one of the at least two audio transmission-reception devices dedicated to a first pre-authorized casino personnel on a game floor of a casino or having reception of the game floor;
e) the feed of at least one of the at least two audio-transmission-reception devices being fed into the central processor is interpreted by the central processor through execution of Large Language Model software, which Large Language Model software converts words spoken by the first pre-authorized casino personnel into digital commands to be executed by the central processor;
f) the central processor is configured to respond to the digital commands by performing at least one action of retrieving content selected from the group consisting of:
1. retrieving specific fields of view from the at least two live video streaming cameras based on time intervals identified in the words spoken by the first pre-authorized casino personnel;
2. retrieving video frames from the at least two live video streaming cameras as identified in the words spoken by the first pre-authorized casino personnel;
3. retrieving an audio feed from one of the audio transmission-reception devices which is not dedicated to the first pre-authorized casino personnel;
g) the central processor receiving digital commands in addition to actions i), ii) and iii) which requires access to content retrieved from actions i), ii) and/or iii) and analyzing the content to determine anomalous behavior of persons or apparatus within the at least two non-identical live video streaming cameras and/or the audio feed from one of the audio transmission-reception devices which is not dedicated to the first pre-authorized casino personnel; and
h) wherein the at least two live video streaming cameras overlap a position on a gaming table wherein wagering elements are placed during execution of a gaming event on the gaming table; and
i) anomalous behavior selected from the group consisting of changing numbers of wagering elements, changing orientation of markings on wagering elements and changes in colors of wagering elements is identified by the central processor analyzing of image feed from the at least two live video streaming cameras during execution of the gaming event on the gaming table.

2. The system of claim 1 wherein the at least two live video streaming cameras having non-identical fields of view are selected from the group consisting of cameras installed on a gaming table, cameras installed on a support adjacent to or attached to a gaming table, eye-in-the-sky cameras attached to walls and/or ceilings, and rotating movement cameras installed above a plane of the surface of a gaming table.

3. The system of claim 1 wherein at least one weight measuring scale is associated with all wagering positions on the gaming table and anomalous behavior in the form of a changing of weight of stacks of wagering elements is identified by the central processor analyzing data from the at least one weight measuring scale.

4. The system of claim 2 wherein feed to the central processor from the at least two live streaming cameras provides facial data of persons within the fields of view from the at least two live streaming cameras, and the central processor is configured to execute facial recognition software on data fed from the at least two live streaming cameras.

5. The system of claim 2 wherein the facial recognition software compares the fed facial data of persons within the field of view to a library of facial data stored in memory identifying at least one library of facial images including members of personal classes selected from the group consisting of criminals, blacklisted players and terrorists.

6. The system of claim 1 wherein the at least one of the at least two audio transmission-reception devices is selected from the group consisting of A) a processor; B) voice receiving and signal transmitting device; and C) a combination of A) and B).

7. The system of claim 4 wherein the central processor is configured to execute voice recognition software upon receiving a voice signal, and the system responding to any command in the voice signal only after the received voice is recognized.

8. The system of claim 1 wherein any command issued from one of the at least two audio transmission-reception devices that requires overt security actions against any player within the casino, such activity in response to a command must be seconded by a second one of the at least two audio transmission-reception devices and the system is configured such that such command will be implemented only upon confirmation of authority of the second one of the at least two audio transmission-reception devices.

9. The system of claim 1 wherein a combination of optics in the at least two video cameras with executable software identifies changes of at least 1° in orientation of markings on wagering elements and color changes of at least 5 nm wavelength.

10. The system of claim 2 wherein the central processor are configured with at least one security function selected from the group consisting of voice recognition, facial recognition, bio-recognition, password protection, and security question clearance.

11. A method for overseeing security at a gaming facility on a system comprising:
a. at least two live video streaming cameras having non-identical fields of view;
b. a feed from the video streaming cameras to a central processor;
c. at least two audio reception devices providing audio feed into the central processor;
wherein at least one of the at least two audio reception devices dedicated to a first pre-authorized casino personnel on a game floor of a casino or having a reception the game floor;
the at least one of the at least two audio transmission-reception devices providing feed being fed into the processor, wherein the feed being fed into the central processor is interpreted by the central processor through execution of Large Language Model software, which Large Language Model software converts words spoken by the first pre-authorized casino personnel into digital commands to be executed by the central processor;
the central processor is configured to respond to at least one digital command converted from the at least one audio feed from the at least one of the at least two audio transmission-reception devices dedicated to the first pre-authorized casino personnel as converted by the Large Language Model into a digital command by performing at least one action of retrieving content selected from the group consisting of:
d. retrieving specific fields of view from the at least two live video streaming cameras based on time intervals identified in the words spoken by the authorized casino personnel;
e. retrieving video frames from the at least two live video streaming cameras as identified in the words spoken by the first pre-authorized casino personnel;
f. retrieving an audio feed from one of the audio transmission-reception devices which is not dedicated to the first pre-authorized casino personnel;
the central processor receiving additional digital commands in addition to actions of retrieving content d), e) and f) which requires access to content retrieved from actions d), e) and/or f) and analyzing the retrieved content of d), e) and f) with content retrieved from the additional digital commands to determine anomalous behavior of persons or apparatus within the non-identical fields of view of the at least two live video streaming cameras and/or the audio feed from one of the audio reception devices which is not dedicated to the first pre-authorized casino personnel;
wherein the method comprising storing feed from the at least two live video streaming cameras having non-identical fields of view into memory accessible by the central processor;
g. the central processor executing software to retrieve content of:
specific fields of view from the at least two live video streaming cameras based on time intervals identified in the words entered by the authorized casino personnel;
video frames from the at least two live video streaming cameras as identified in the words entered by the first pre-authorized casino personnel; and
a feed from one of the audio transmission-reception devices which is not dedicated to the first pre-authorized casino personnel;
h. the central processor identifying at least one instance of anomalous activity observed in response to analysis of content from at least one of 1), 2) and/or 3) after response to the at least one digital command converted from the at least one feed from the at least one of the at least two audio transmission-reception devices dedicated to a first pre-authorized casino personnel as converted by the Large Language Model into a digital command; and
i, wherein the at least two live video streaming cameras overlap a position on a gaming table wherein wagering elements are placed during execution of a gaming event on the gaming table; and
j. anomalous behavior in the form of changing numbers of wagering elements and/or changes in colors of wagering elements is identified by the central processor analyzing of image feed from the at least two live video streaming cameras during execution of the gaming event on the gaming table.

12. The method of claim 11 wherein the at least two live video streaming cameras having non-identical fields of view are selected from the group consisting of cameras installed on a gaming table, cameras installed on a support adjacent to or attached to a gaming table, eye-in-the-sky cameras attached to walls and/or ceilings, and rotating movement cameras installed above a plane of the surface of a gaming table, and the at least two live streaming cameras feed data in real time to the central processor where the feed is stored in memory.

13. The system of claim 12 wherein feed to the central processor from the at least two live streaming cameras provide facial data of persons within the fields of view from the at least two live streaming cameras, and the central processor is configured to execute facial recognition software on data fed from the at least two live streaming cameras.

14. The method of claim 13 wherein the facial recognition software compares the fed facial data of persons within the field of view to a library of facial data stored in memory identifying at least one library of facial images including members of personal classes selected from the group consisting of criminals, blacklisted players and terrorists, and upon having a baseline match of fed facial data of persons within the field of view to an individual within the at least one library, an alert is sent through the system indicating that such a baseline match has been made, and identifying in the alert a location of the person within the field of view that caused the alert.

15. The method of claim 11 wherein commands are directed to the central processor from the at least one of the at least two audio transmission-reception devices which are selected from the group consisting of A) a processor; B) voice receiving and signal transmitting device; and C) a combination of A) and B).

16. The method of claim 14 wherein the central processor executes voice recognition software upon receiving a voice signal, and the system responds to any command in the voice signal only after the received voice is recognized.

17. The method of claim 10 wherein a command issued from one of the at least two audio transmission-reception devices that requires overt security actions against any person within the casino, such activity in response to a command is seconded by a second one of the at least two audio transmission-reception devices and the system implements that command only upon confirmation of authority of the second one of the at least two audio transmission-reception devices.

18. The method of claim 11 wherein the processor executes at least one security function selected from the group consisting of voice recognition, facial recognition, bio-recognition, password protection, and security question clearance.

19. The method of claim 11 wherein at least one weight measuring scale is associated with all wagering positions on the gaming table and anomalous behavior in the form of changing weight of stacks of wagering elements is identified by the central processor analyzing data from the at least one weight measuring scale.

20. The method of claim 1 wherein a combination of optics in the at least two video cameras with executable software identifies changes of at least 1° in orientation of markings on wagering elements or color changes of at least 5 nm wavelength, and the occurrence of either of the changes triggers a system alert.
